(19) United States
(12) Patent Application Publication
(10) Pub. No.: US 2026/0303334 A1
(43) Pub. Date: Oct. 1, 2026

(54) ENCRYPTED EMBEDDING SEARCH FOR RETRIEVAL-AUGMENTED GENERATION APPLICATIONS

(71) Applicant: Mirror Security Limited, Dublin (IE)

(72) Inventor: Aditya Kuppa, Dublin (IE)

(21) Appl. No.: 19/391,299

(22) Filed: Nov. 17, 2025

Related U.S. Application Data
(60) Provisional application No. 63/777,627, filed on Mar. 25, 2025.

(51) Int. Cl. H04L 9/08; G06F 16/22; G06F 16/28; H04L 9/00

(52) U.S. Cl. CPC H04L 9/0861; G06F 16/2228; G06F 16/282; H04L 9/008

(57) ABSTRACT

Encrypted embedding search for retrieval-augmented generation is provided. A computer-implemented method comprises receiving an encrypted query embedding associated with a search request. The method includes traversing a hybrid search index structure to identify candidate nodes from a plurality of nodes, where each node is associated with a respective encrypted embedding comprising ciphertexts corresponding to elements of an embedding vector. The respective encrypted embedding comprises ciphertexts corresponding to elements of an embedding vector of a plurality of embedding vectors. The method includes performing homomorphic similarity computations between the encrypted query embedding and the respective encrypted embedding associated with each candidate node. The method includes generating similarity scores based on the homomorphic similarity computations and generating a search result corresponding to the search request based on the similarity scores.

### CROSS-REFERENCE TO RELATED APPLICATIONS/INCORPORATION BY REFERENCE

This application claims priority to U.S. Provisional Patent Application Ser. No. 63/777,627 filed on Mar. 25, 2025, the entire content of which is hereby incorporated herein by reference.

### BACKGROUND

Modern information systems increasingly rely on vector embeddings for semantic search and data retrieval applications across diverse domains including natural language processing, computer vision, recommendation systems, and knowledge management. Vector embeddings transform complex data such as text, images, and structured information into high-dimensional numerical representations that capture semantic relationships and enable similarity-based search operations. As organizations process growing volumes of sensitive data in cloud environments and distributed systems, there is increasing demand for privacy-preserving search capabilities that can maintain data confidentiality while enabling effective search operations. Traditional approaches often require data to be processed in plaintext, which can expose sensitive information during computation and storage, presenting challenges for organizations that need to balance functionality with privacy requirements. This is particularly critical in regulated industries such as healthcare, finance, and legal services, where data protection regulations and privacy concerns necessitate robust security measures throughout the data processing pipeline.

### SUMMARY

In various embodiments of the disclosure, a computer-implemented method for privacy-preserving encrypted embedding search is described. The method includes receiving an encrypted query embedding of a query embedding vector associated with a search request. The method further includes traversing a hybrid search index structure to identify a set of candidate nodes from a plurality of nodes of the hybrid search index structure. Each node of the plurality of nodes is associated with a respective encrypted embedding of a plurality of encrypted embeddings, and the respective encrypted embedding comprises ciphertexts corresponding to elements of an embedding vector of a plurality of embedding vectors. The method also includes performing homomorphic similarity computations between the encrypted query embedding and the respective encrypted embedding associated with each candidate node of the set of candidate nodes. Additionally, the method includes generating similarity scores based on the homomorphic similarity computations. The method further includes generating a search result corresponding to the search request based on the similarity scores.

Further aspects of the present disclosure are directed to systems and computer program products containing functionality consistent with the method described above.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a network environment for encrypted embedding search, in accordance with an embodiment of the disclosure;

FIGS. 2A and 2B are diagrams illustrating a flowchart of an encrypted embedding search process in a retrieval-augmented generation system, in accordance with an embodiment of the disclosure;

FIG. 3 is a flowchart that illustrates constructing a hybrid search index structure with encrypted embeddings, in accordance with an embodiment of the disclosure;

FIG. 4 is a diagram that illustrates a flowchart for an encrypted search process using homomorphic similarity computations, in accordance with an embodiment of the disclosure.

FIG. 5 is a flowchart that illustrates an encrypted search process using homomorphic similarity computations, in accordance with an embodiment of the disclosure; and

FIG. 6 is a diagram that illustrates a computer system for implementing privacy-preserving encrypted embedding search operations, in accordance with an embodiment of the disclosure.

### DETAILED DESCRIPTION

In modern data processing environments, organizations face substantial challenges in maintaining privacy while performing semantic search operations on sensitive vector embeddings. As machine learning applications increasingly rely on vector databases for retrieval-augmented generation and similarity search tasks, the need to protect proprietary data during search operations has become paramount. Traditional approaches to encrypted search may suffer from computational inefficiencies, particularly when dealing with high-dimensional embedding vectors that require complex similarity computations. The computational overhead associated with fully homomorphic encryption operations may result in prohibitive latency for real-time applications, while noise accumulation during homomorphic operations may degrade search accuracy over time.

Conventional fully homomorphic encryption schemes may encounter significant challenges when applied to vector similarity search operations. Noise growth during homomorphic multiplication and addition operations may necessitate frequent bootstrapping procedures, which may introduce substantial computational delays. The multiplicative depth limitations of homomorphic encryption circuits may restrict the complexity of similarity computations that can be performed without decryption. Additionally, existing encrypted search systems may rely on linear search approaches that scale poorly with database size, making such approaches impractical for large-scale embedding collections. These limitations may prevent organizations from deploying privacy-preserving search solutions in production environments where both security and performance are required.

To address these challenges, a computer-implemented method and a system for privacy-preserving encrypted embedding search has been developed. This method provides a comprehensive system that integrates fully homomorphic encryption with hybrid search index structures to enable efficient privacy-preserving search operations. The system utilizes advanced preprocessing techniques including vector normalization, scaling transformations, and randomization factors to reduce ciphertext expansion and minimize noise accumulation during homomorphic similarity computations. The preprocessing optimizations may achieve ciphertext expansion reduction of about 85-90% in some cases, significantly extending the feasibility of encrypted computations. This approach helps overcome the computational bottlenecks associated with traditional fully homomorphic encryption while maintaining strong security guarantees based on the Ring Learning with Errors problem.

The present disclosure describes a computer-implemented method for encrypted embedding search that addresses the aforementioned challenges by providing a hybrid approach that combines the security benefits of fully homomorphic encryption with the efficiency of approximate nearest neighbor search algorithms. The method includes receiving an encrypted query embedding of a query embedding vector associated with a search request, traversing a hybrid search index structure to identify a set of candidate nodes from a plurality of nodes of the hybrid search index structure, performing homomorphic similarity computations between the encrypted query embedding and encrypted embeddings associated with each candidate node of the set of candidate nodes, generating similarity scores based on the homomorphic similarity computations, and generating a search result corresponding to the search request based on the similarity scores. The system processes encrypted data through a sequence of operations that maintain privacy throughout the search process without requiring decryption of sensitive embeddings. The system may be implemented through a software development kit (SDK) layer that transparently intercepts vector database operations, enabling integration with existing vector databases.

The method involves constructing a hybrid search index structure that combines encrypted node data with plaintext connectivity information. The hybrid search index structure comprises a Navigable Small-World Graph (NSW) graph or Hierarchical Navigable Small World (HNSW) graph where encrypted embeddings are stored as node data while edge connectivity remains in plaintext to enable efficient graph traversal. Each node of the plurality of nodes is associated with an encrypted embedding of a plurality of encrypted embeddings. The encrypted embedding comprises ciphertexts corresponding to elements of an embedding vector of a plurality of embedding vectors. In RLWE-based encryption schemes, ciphertexts are represented as polynomials over a ring (often modulo a cyclotomic polynomial and an integer). The plaintext connectivity information allows the system to perform rapid graph navigation without homomorphic operations, while homomorphic similarity computations are performed only on candidate nodes identified during traversal. This hybrid approach achieves sublinear search complexity while maintaining complete privacy of the underlying embedding data.

The system employs advanced preprocessing techniques to optimize homomorphic operations and reduce computational overhead. The preprocessing pipeline includes normalizing each embedding vector of an initial plurality of embedding vectors to unit length to obtain a plurality of normalized embedding vectors, applying scaling transformations based on specific scaling factors to each normalized embedding vector to obtain a plurality of scaled embedding vectors, and adding randomization factors from multivariate normal distributions to each scaled embedding vector to obtain the plurality of embedding vectors suitable for encryption. These preprocessing steps reduce ciphertext expansion by substantial percentages and minimize noise growth during subsequent homomorphic similarity computations. The normalization process ensures consistent similarity calculations in the encrypted domain, while scaling transformations optimize the dynamic range of encrypted values to reduce noise accumulation. The preprocessing optimizations enable the system to run on traditional hardware without requiring specialized accelerators, making deployment more practical for organizations.

When processing search requests, the system performs homomorphic similarity computations using optimized homomorphic dot product operations that minimize bootstrapping requirements. Each homomorphic dot product operation comprises element-wise homomorphic multiplication between ciphertexts of the encrypted query embedding and ciphertexts of the encrypted embedding associated with each candidate node, re-linearization of each multiplication result based on evaluation keys to generate re-linearized multiplication results, and homomorphic addition of the re-linearized multiplication results to generate a respective similarity score of the similarity scores. The evaluation keys are generated based on sampling of discrete Gaussian distributions over a polynomial ring, providing the cryptographic foundation for efficient re-linearization operations that control ciphertext size and noise growth. Each of the homomorphic similarity computations is performed during the traversal at a respective candidate node of the set of candidate nodes, and the traversal is based on a priority queue of the set of candidate nodes ordered by the similarity scores. The system supports various distance metrics including homomorphic versions of dot product, Euclidean distance, or Hamming distance to accommodate different similarity measurement requirements.

The system supports multiple homomorphic encryption schemes to accommodate different data types and security requirements. The homomorphic encryption scheme is selected based on a data type of the elements in the embedding vector, with options including, but not limited to, Cheon-Kim-Kim-Song (CKKS) scheme for floating-point operations, Brakerski/Fan-Vercauteren (BFV) scheme for integer operations, Brakerski-Gentry-Vaikuntanathan (BGV) scheme for general computations, Fully Homomorphic Encryption over Torus (TFHE) scheme for Boolean operations, or Ring Learning with Errors (RLWE) scheme for various applications. The system also supports Gaussian-based schemes (GMEW) for specialized applications. This flexibility allows the system to optimize performance and security characteristics based on specific use case requirements and data characteristics, including support for both floating point embeddings and integer embeddings. The system further includes sampling discrete Gaussian distributions over a polynomial ring to generate a public key and a secret key, and encrypting the plurality of embedding vectors based on the public key to generate the plurality of encrypted embeddings.

The method incorporates retrieval-augmented generation capabilities by integrating encrypted search results with language processing systems. The system identifies, from the plurality of encrypted embeddings, a set of encrypted embeddings similar to the encrypted query embedding based on the similarity scores, applies a homomorphic decryption scheme to the identified set of encrypted embeddings to generate a set of decrypted embedding vectors, and queries a vector database to retrieve a set of context documents associated with the set of decrypted embedding vectors. The set of context documents is ranked based on the similarity scores, and at least one context document is selected from the ranked set of context documents. A neural language model is fed with a prompt comprising the at least one context document and content of the search request to generate response data, and the search result is generated based on the response data. This integration enables privacy-preserving retrieval-augmented generation applications where sensitive data remains encrypted throughout the search process, particularly beneficial for private RAG systems that process proprietary corporate data, private cloud storage content, or sensitive information in regulated industries.

The system implements advanced key management architectures to support multi-tenant deployments and role-based access control. The cryptographic framework utilizes index-level secret keys as master keys for database or index-level encryption, with individual user keys derived from the master secret to enable selective access to encrypted data. The derived keys include access permissions and enable client-side decryption of authorized results while maintaining complete privacy of unauthorized data. The homomorphic decryption scheme comprises applying a secret key or a derived secret key to the identified set of encrypted embeddings to generate the set of decrypted embedding vectors. The secret key is based on a sampling of discrete Gaussian distributions over a polynomial ring. This hierarchical key management approach facilitates secure multi-party scenarios where different users can decrypt only their authorized results without exposing sensitive information to other parties or the service provider. The key derivation process enables role-based access control where derived keys can include specific access permissions for different user roles or organizational units.

The system provides comprehensive integration capabilities with existing vector database infrastructures through software development kit layers. The integration framework includes SDK components that intercept vector database operations, automatically encrypting embeddings before upload and encrypting query vectors during search operations. The system maintains compatibility with existing vector databases while transparently adding encryption capabilities to standard workflows. The SDK handles decryption of search results and supports various distance metrics through homomorphic implementations, enabling organizations to add privacy-preserving capabilities to existing vector search applications without requiring substantial architectural changes. The identification of the set of candidate nodes is performed without a decryption of the ciphertexts of the encrypted embedding and ciphertexts of the encrypted query embedding, ensuring complete privacy preservation during the traversal process.

The system offers several advantages over conventional encrypted search approaches. The hybrid architecture achieves search latencies that are orders of magnitude faster than linear encrypted search methods while maintaining stronger security guarantees than partially homomorphic approaches. The reduced bootstrapping frequency enables practical deployment in real-time applications where traditional fully homomorphic encryption would be prohibitively slow. The advanced noise management techniques minimize the need for expensive bootstrapping operations, with the system requiring bootstrapping significantly less frequently than traditional FHE systems. The preprocessing optimizations reduce memory requirements and ciphertext sizes, making the system viable for large-scale embedding collections. Additionally, the support for multiple encryption schemes and flexible key management enables multi-tenant deployments where different users can access authorized subsets of encrypted data using derived keys.

In various embodiments of the disclosure, a computer-implemented method is described. The method includes, in a computer system that comprises a processor, receiving an encrypted query embedding of a query embedding vector associated with a search request. The method further includes traversing a hybrid search index structure to identify a set of candidate nodes from a plurality of nodes of the hybrid search index structure. Each node of the plurality of nodes is associated with a respective encrypted embedding of a plurality of encrypted embeddings. The respective encrypted embedding comprises ciphertexts corresponding to elements of an embedding vector of a plurality of embedding vectors. The method further includes performing homomorphic similarity computations between the encrypted query embedding and the respective encrypted embedding associated with each candidate node of the set of candidate nodes. The method further includes generating similarity scores based on the homomorphic similarity computations. The method further includes generating a search result corresponding to the search request based on the similarity scores.

In various embodiments of the disclosure, the encrypted query embedding comprises ciphertexts corresponding to elements of the query embedding vector.

In various embodiments of the disclosure, the method further includes retrieving an initial plurality of embedding vectors from a vector database. The method further includes preprocessing the initial plurality of embedding vectors through a normalization and transformation pipeline to obtain the plurality of embedding vectors. The method further includes encrypting each embedding vector of the plurality of embedding vectors based on a homomorphic encryption scheme to generate the plurality of encrypted embeddings. The plurality of encrypted embeddings comprises the respective encrypted embedding of each embedding vector of the plurality of embedding vectors. The method further includes constructing the hybrid search index structure comprising a Navigable Small-World Graph (NSW) graph. The NSW graph comprises the plurality of nodes and edges between the plurality of nodes. Connectivity information for the edges is in plaintext.

In various embodiments of the disclosure, the NSW graph is a hierarchical navigable small world (HNSW) graph. The plurality of nodes of the HNSW graph is spread across hierarchical levels of the HNSW graph. The traversal of the hybrid search index structure is a progressive traversal across the hierarchical levels of the HNSW graph to identify the set of candidate nodes.

In various embodiments of the disclosure, the preprocessing comprises normalizing each embedding vector of the initial plurality of embedding vectors to a unit length to obtain a plurality of normalized embedding vectors. The preprocessing further comprises applying a scaling transformation based on specific scaling factors to each normalized embedding vector of the plurality of normalized embedding vectors to obtain a plurality of scaled embedding vectors. The preprocessing further comprises adding a randomization factor from a multivariate normal distribution to each scaled embedding vector of the plurality of scaled embedding vectors to obtain the plurality of embedding vectors.

In various embodiments of the disclosure, the homomorphic encryption scheme comprises a fully homomorphic encryption (FHE) scheme based on a Ring Learning with Errors (RLWE) problem.

In various embodiments of the disclosure, the method further includes selecting the homomorphic encryption scheme based on a data type of the elements in the embedding vector. The homomorphic encryption scheme comprises at least one of Cheon-Kim-Kim-Song (CKKS) scheme, Brakerski/Fan-Vercauteren (BFV) scheme, Brakerski-Gentry-Vaikuntanathan (BGV) scheme, Fully Homomorphic Encryption over Torus (TFHE) scheme, or Ring Learning with Errors (RLWE) scheme.

In various embodiments of the disclosure, the method further includes sampling discrete Gaussian distributions over a polynomial ring to generate a public key and a secret key. The method further includes encrypting the plurality of embedding vectors based on the public key to generate the plurality of encrypted embeddings.

In various embodiments of the disclosure, the method further includes identifying, from the plurality of encrypted embeddings, a set of encrypted embeddings similar to the encrypted query embedding based on the similarity scores. The method further includes applying a homomorphic decryption scheme to the identified set of encrypted embeddings to generate a set of decrypted embedding vectors. The method further includes querying a vector database to retrieve a set of context documents associated with the set of decrypted embedding vectors. The method further includes generating the search result further based on the set of context documents.

In various embodiments of the disclosure, the method further includes ranking the set of context documents based on the similarity scores. The method further includes selecting at least one context document from the ranked set of context documents. The method further includes feeding a neural language model with a prompt comprising the at least one context document and content of the search request to generate response data. The method further includes generating the search result based on the response data.

In various embodiments of the disclosure, the applying of the homomorphic decryption scheme comprises applying a secret key or a derived secret key to the identified set of encrypted embeddings to generate the set of decrypted embedding vectors. The secret key is based on a sampling of discrete Gaussian distributions over a polynomial ring.

In various embodiments of the disclosure, the performing of the homomorphic similarity computations comprises performing homomorphic dot product operations between the encrypted query embedding and the respective encrypted embedding associated with each respective candidate node of the set of candidate nodes.

In various embodiments of the disclosure, each of the homomorphic dot product operations comprises an element-wise homomorphic multiplication between ciphertexts of the encrypted query embedding and the ciphertexts of the respective encrypted embedding to generate multiplication results. Each operation further comprises a re-linearization of each of the multiplication results based on evaluation keys to generate re-linearized multiplication results. Each operation further comprises a homomorphic addition of the re-linearized multiplication results to generate a respective similarity score of the similarity scores. The evaluation keys are based on a sampling of discrete Gaussian distributions over a polynomial ring.

In various embodiments of the disclosure, each of the homomorphic similarity computations is performed during the traversal at a respective candidate node of the set of candidate nodes. The traversal is based on a priority queue of the set of candidate nodes ordered by the similarity scores.

In various embodiments of the disclosure, the identification of the set of candidate nodes is performed without a decryption of the ciphertexts of the respective encrypted embedding and ciphertexts of the encrypted query embedding.

In various embodiments of the disclosure, a computer system is described. The computer system comprises a processor configured to receive an encrypted query embedding of a query embedding vector associated with a search request. The processor is further configured to traverse a hybrid search index structure to identify a set of candidate nodes from a plurality of nodes of the hybrid search index structure. Each node of the plurality of nodes is associated with an encrypted embedding of a plurality of encrypted embeddings. The respective encrypted embedding comprises ciphertexts corresponding to elements of an embedding vector of a plurality of embedding vectors. The processor is further configured to perform homomorphic similarity computations between the encrypted query embedding and the respective encrypted embedding associated with each candidate node of the set of candidate nodes. The processor is further configured to generate similarity scores based on the homomorphic similarity computations. The processor is further configured to generate a search result corresponding to the search request based on the similarity scores.

In various embodiments of the disclosure, the processor is further configured to retrieve an initial plurality of embedding vectors from a vector database. The processor is further configured to preprocess the initial plurality of embedding vectors through a normalization and transformation pipeline to obtain the plurality of embedding vectors. The processor is further configured to encrypt each embedding vector of the plurality of embedding vectors based on a homomorphic encryption scheme to generate a plurality of encrypted embeddings. The plurality of encrypted embeddings comprises the respective encrypted embedding of each embedding vector of the plurality of embedding vectors. The processor is further configured to construct the hybrid search index structure comprising a Navigable Small-World Graph (NSW) graph. The NSW graph comprises the plurality of nodes and edges between the plurality of nodes. Connectivity information for the edges is in plaintext.

In various embodiments of the disclosure, the processor is further configured to identify, from the plurality of encrypted embeddings, a set of encrypted embeddings similar to the encrypted query embedding based on the similarity scores. The processor is further configured to apply a homomorphic decryption scheme to the identified set of encrypted embeddings to generate a set of decrypted embedding vectors. The processor is further configured to query a vector database to retrieve a set of context documents associated with the set of decrypted embedding vectors. The processor is further configured to generate the search result further based on the set of context documents.

In various embodiments of the disclosure, the identification of the set of candidate nodes is performed without a decryption of the ciphertexts of the respective encrypted embedding and ciphertexts of the encrypted query embedding.

In various embodiments of the disclosure, a computer program product is described. The computer-program product comprises one or more computer-readable storage media. The computer-program product further comprises program instructions stored on the one or more computer-readable storage media to perform operations comprising receiving an encrypted query embedding of a query embedding vector associated with a search request. The operations further comprise traversing a hybrid search index structure to identify a set of candidate nodes from a plurality of nodes of the hybrid search index structure. Each node of the plurality of nodes is associated with a respective encrypted embedding of a plurality of encrypted embeddings. The respective encrypted embedding comprises ciphertexts corresponding to elements of an embedding vector of a plurality of embedding vectors. The operations further comprise performing homomorphic similarity computations between the encrypted query embedding and the respective encrypted embedding associated with each candidate node of the set of candidate nodes. The operations further comprise generating similarity scores based on the homomorphic similarity computations. The operations further comprise generating a search result corresponding to the search request based on the similarity scores.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

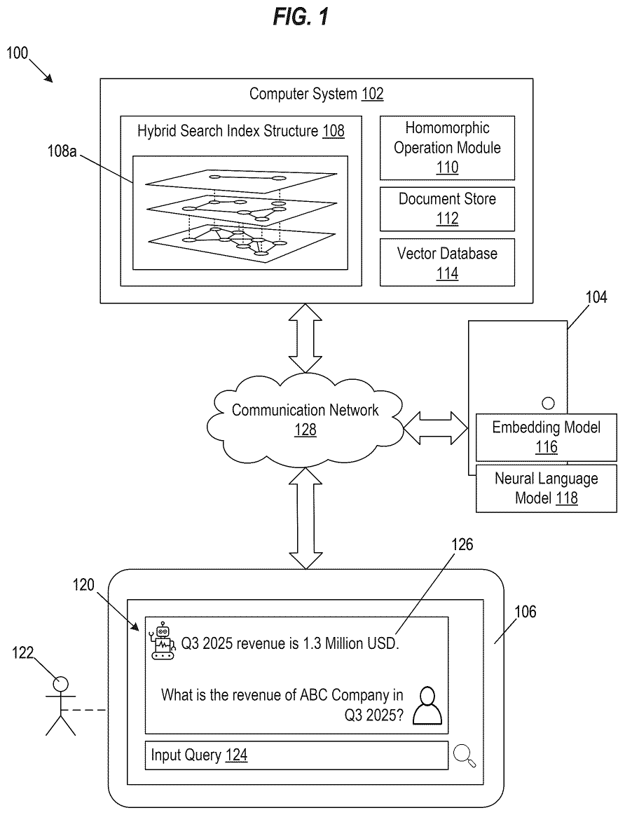

FIG. 1 is a diagram that illustrates a network environment 100 for encrypted embedding search, in accordance with an embodiment of the disclosure. With reference to FIG. 1, there is shown a diagram of the network environment 100. The network environment 100 includes a computer system 102, a server 104, a user device 106, a hybrid search index structure 108, a Navigable Small World (NSW) graph 108a, a homomorphic operation module 110, a document store 112, a vector database 114, an embedding model 116, a neural language model 118, a user interface 120, a user 122, an input query 124, response data 126, and a communication network 128.

The computer system 102 includes suitable logic, circuitry, and interfaces for receiving an encrypted query embedding of a query embedding vector associated with a search request, traversing the hybrid search index structure 108 to identify a set of candidate nodes from a plurality of nodes, performing homomorphic similarity computations between the encrypted query embedding and encrypted embeddings associated with each candidate node of the set of candidate nodes, generating similarity scores based on the homomorphic similarity computations, and generating a search result corresponding to the search request based on the similarity scores. The computer system 102 may include a processor set, one or more computer-readable storage media, and program instructions stored on the one or more computer-readable storage media that are executable by the processor set. The computer system 102 may be configured to process encrypted embedding data and execute homomorphic operations to facilitate privacy-preserving search operations without requiring decryption of sensitive data. The computer system 102 may be implemented as a software development kit (SDK) that intercepts vector database operations and provides encryption to existing vector databases such as vector databases, cloud-based vector search services, and relational databases with vector extensions. The computer system 102 may support multiple homomorphic encryption schemes including, but not limited to, Cheon-Kim-Kim-Song (CKKS) scheme, Brakerski/Fan-Vercauteren (BFV) scheme, Brakerski-Gentry-Vaikuntanathan (BGV) scheme, Fully Homomorphic Encryption over Torus (TFHE) scheme, Ring Learning with Errors (RLWE) scheme, and Gaussian-based schemes (GMEW). Examples of the computer system 102 include, but are not limited to, a server, a computing device, a virtual computing device, a mainframe machine, a computer workstation, a cloud-based service, a distributed computing system, or a specialized cryptographic processing device.

The server 104 includes suitable logic, circuitry, and interfaces for communicating with the computer system 102 through the communication network 128. The server 104 may store neural language models and embedding models for processing natural language inputs and generating vector embeddings. In some cases, the server 104 may provide machine learning services or serve as a centralized repository for trained models used in retrieval-augmented generation applications. The server 104 plays a role in maintaining the security and integrity of the computer system 102 by managing access controls and validating user identities across various applications and services. The server 104 may implement various security protocols, such as authentication protocols, certificate-based authentication, or multi-factor authentication, to ensure that only authorized users can access sensitive organizational data and encrypted search capabilities. The server 104 may implement hierarchical key management architectures with index-level secret keys as master keys for databases or index-level encryption, and individual user keys derived from the master secret to enable selective access to encrypted embeddings.

The server 104 may be implemented as a physical server, a virtual machine, or a container in a cloud environment, providing scalability to handle large volumes of authentication requests, machine learning inference operations, and encrypted search services. Examples of the server 104 may include, but are not limited to, a web server, an application server, a machine learning inference server, a model hosting platform, a cloud computing instance, a cloud-based virtual server instance running directory services, a cloud virtual machine hosting identity management systems, an on-premises rack-mounted server with authentication services, or a containerized deployment of machine learning services running on an enterprise container orchestration platform. In at least one embodiment, the server 104 may be implemented as a plurality of distributed cloud-based resources using technologies well known to those ordinarily skilled in the art. In certain embodiments, the functionalities of the server 104 can be incorporated entirely or at least partially in the computer system 102 without departing from the scope of the disclosure.

The user device 106 may be a computing system that enables user interaction with the computer system 102 through the communication network 128. The user device 106 may transmit search requests and receive search results while maintaining privacy of the underlying query data through encryption. The user device 106 may perform client-side decryption of authorized results using derived keys while maintaining complete privacy of unauthorized data. In some cases, the user device 106 may provide client-side encryption capabilities or serve as an interface for accessing search services. The user device 106 may be implemented as a desktop computer, laptop, mobile device, or specialized secure computing terminal. Examples of the user device 106 may include, but are not limited to, a smartphone, tablet, personal computer, workstation, secure terminal, or any computing device capable of processing encrypted data and communicating over networks.

The hybrid search index structure 108 may include suitable logic, circuitry, or interfaces that may be configured to store encrypted embeddings while maintaining plaintext connectivity information to enable efficient traversal during search operations. The hybrid search index structure 108 comprises various data structures including the NSW graph 108a, tree-based structures, hash-based indices, or other indexing mechanisms that facilitate approximate nearest neighbor search through hierarchical navigation. Each node of a plurality of nodes in the hybrid search index structure 108 is associated with an encrypted embedding of a plurality of encrypted embeddings. Each encrypted embedding represents a data item or content item to be searched and comprises ciphertexts corresponding to elements of an embedding vector that captures semantic characteristics of the associated data item. The ciphertexts are represented as polynomials over a ring (often modulo a cyclotomic polynomial and a large integer) and noise is added to ensure security. The hybrid search index structure 108 enables sublinear search complexity while preserving complete privacy of the underlying data items and their semantic representations through homomorphic encryption. Examples of the hybrid search index structure 108 may include, but are not limited to, an encrypted hierarchical navigable small world (HNSW) graph, an approximate nearest neighbor index, a homomorphic encryption-based search structure, or a hybrid plaintext-ciphertext graph database.

The NSW graph 108a may be a hierarchical navigable small world (HNSW) graph that comprises the plurality of nodes and edges between the plurality of nodes, with connectivity information for the edges maintained in plaintext. The NSW graph 108a is depicted as multiple interconnected layers representing the hierarchical structure of the graph, and the plurality of nodes of the HNSW graph is spread across hierarchical levels of the HNSW graph. The NSW graph 108a comprises nodes and edges that facilitate traversal during search operations, enabling progressive traversal across the hierarchical levels of the HNSW graph to identify a set of candidate nodes. The NSW graph 108a enables graph navigation without requiring homomorphic operations on connectivity data, while homomorphic similarity computations are performed only on candidate nodes identified during traversal. The traversal of the hybrid search index structure 108 is a progressive traversal across the hierarchical levels of the HNSW graph to identify the set of candidate nodes.

The homomorphic operation module 110 may include suitable logic, circuitry, and interfaces configured to perform homomorphic similarity computations between encrypted query embeddings and encrypted embeddings associated with candidate nodes without requiring decryption of the underlying encrypted embeddings. The homomorphic operation module 110 includes suitable logic, circuitry, and interfaces configured to execute homomorphic dot product operations, element-wise homomorphic multiplication between ciphertexts of the encrypted query embedding and ciphertexts of the encrypted embedding, re-linearization of multiplication results based on evaluation keys to generate re-linearized multiplication results, and homomorphic addition of the re-linearized multiplication results to generate similarity scores. The evaluation keys are generated based on sampling of discrete Gaussian distributions over a polynomial ring. The homomorphic operation module 110 supports multiple distance metrics including homomorphic versions of dot product, Euclidean distance, and Hamming distance to accommodate different similarity measurement requirements. Each of the homomorphic similarity computations is performed during the traversal at a respective candidate node of the set of candidate nodes, and the traversal is based on a priority queue of the set of candidate nodes ordered by the similarity scores. The homomorphic operation module 110 may work in conjunction with the hybrid search index structure 108 to provide encrypted search capabilities while maintaining privacy throughout the computation process. Examples of the homomorphic operation module 110 may include, but are not limited to, a fully homomorphic encryption processor, a cryptographic computation engine, a co-processor for homomorphic operation, a Graphical Processing Unit (GPU), or a specialized homomorphic arithmetic unit.

The document store 112 may include suitable logic, circuitry, or interfaces that may maintain documents and associated data that correspond to the encrypted embeddings stored in the hybrid search index structure 108, including textual documents such as articles, reports, and research papers, image files containing photographs, diagrams, illustrations, and technical drawings, audio files including speech recordings, music, podcasts, and sound effects, video content with visual and temporal information such as presentations, tutorials, and multimedia recordings, and multimodal documents that combine multiple data types such as presentations with embedded images and audio, interactive documents with multimedia elements, or technical manuals containing text, diagrams, and video demonstrations. The document store 112 may be accessed by the computer system 102 to retrieve a set of context documents associated with a set of decrypted embedding vectors identified through encrypted search operations. The set of context documents may be ranked based on the similarity scores, and at least one context document may be selected from the ranked set of context documents. In some cases, the document store 112 may store metadata, document content, multimedia assets, or reference information that enables retrieval-augmented generation applications to access relevant content based on search results. Examples of the document store 112 may include, but are not limited to, a document database, a content management system, a file storage repository, a distributed document store, or a cloud-based document service.

The vector database 114 includes suitable logic, circuitry, and interfaces that may be configured to store and retrieve vector embeddings. The vector database 114 may store an initial plurality of embedding vectors corresponding to documents maintained in the document store 112. Such embedding vectors capture the semantic meaning of content in the documents. The vector database 114 may be queried to retrieve a set of context documents associated with a set of decrypted embedding vectors generated through homomorphic decryption of search results. The vector database 114 serves as a data source for constructing the hybrid search index structure 108, providing the initial plurality of embedding vectors that are processed through the homomorphic operation module 110 to create encrypted embeddings. The computer system 102 retrieves embedding vectors from the vector database 114 and applies preprocessing techniques including normalization, scaling transformations, and randomization factors before encrypting each embedding vector using homomorphic encryption schemes. These encrypted embeddings are then organized into the NSW graph 108a within the hybrid search index structure 108, where each node is associated with an encrypted embedding comprising ciphertexts corresponding to elements of the original embedding vectors. The homomorphic operation module 110 enables the creation of this search structure by encrypting the vector embeddings while maintaining their semantic relationships through the graph connectivity. Examples of the vector database 114 may include, but are not limited to, cloud-based vector search services, distributed vector databases, relational databases with vector extensions, graph-based vector databases, in-memory vector databases, or specialized high-dimensional vector storage systems that provide the source data for encrypted index construction.

The embedding model 116 may be a machine learning component that generates vector embeddings from input data, converting textual or other data types into high-dimensional vector representations suitable for similarity search operations. The embedding model 116 includes suitable logic, circuitry, and interfaces configured to process various data types and generate embedding vectors that can be encrypted and stored in the hybrid search index structure 108. The embedding model 116 may utilize transformer-based architecture, neural networks, or other machine learning approaches to create meaningful vector representations of input document. The embedding model 116 may include word embedding models, contextual embedding frameworks, sentence transformer architectures, or semantic representation models, which convert text or other modalities into numerical vectors that capture semantic meaning. Specific implementations of the embedding model 116 might use pre-trained models such as bidirectional encoder representations from transformers embeddings, generative pre-trained transformer embeddings, or domain-specific embeddings trained on domain data. The embedding model 116 may generate fixed-length vector embeddings for documents, which can be compared using similarity measures such as cosine similarity or Euclidean distance. These vector embeddings may capture various aspects of input document, including topic, sentiment, intent, and contextual relationships between concepts in the content of the input document. The embedding process may include preprocessing operations such as tokenization, stop word removal, or lemmatization to improve the quality of the resulting vector embeddings. The embedding model 116 may also implement techniques for handling out-of-vocabulary terms or specialized jargon. In some implementations, the embedding model 116 may generate multiple vector embeddings for different aspects of a document, such as separate vector embeddings for the title, content, and metadata, allowing for more nuanced similarity comparisons. Examples of the embedding model 116 may include, but are not limited to, sentence transformer models, contrastive language-image pre-training models, transformer-based encoders, vision embedding models, audio embedding models, convolutional neural networks for image embeddings, general-purpose text embedding models, universal sentence encoding systems, neural network-based sentence representation models, transformer-based sentence embedding frameworks, contextual embedding models, multilingual embedding systems, or specialized domain-specific embedding models.

The neural language model 118 may be configured to process natural language inputs and generate responses based on context documents retrieved through encrypted search operations. The neural language model 118 may be fed with a prompt comprising at least one context document and content of a search request (for example, a natural language query) to generate response data for retrieval-augmented generation applications. The neural language model 118 may be implemented as a pre-trained neural network (with learned parameters) with a plurality of layers, including an input layer, one or more hidden layers, and an output layer. In some instances, the neural language model 118 may utilize transformer architectures, attention mechanisms, or other neural network components to understand contextual relationships and generate coherent responses. The neural language model 118 may include large language models, transformer-based text generators, autoregressive language models, or multi-modal artificial intelligence systems, which can understand and generate human-like text based on the input the neural language model 118 receives. For example, the neural language model 118 may be used to summarize digital interactions between individuals, extract key information from reports, extract context from code files for coding assistance, and generate natural language responses to user queries. The architecture of the neural language model 118 is based on neural network components, such as the transformer architecture that uses attention mechanisms to capture long-range dependencies and contextual relationships within the input document. The neural language model 118 may incorporate mechanisms for maintaining factual accuracy and avoiding hallucinations, such as retrieval-augmented generation techniques that ground responses in the retrieved data. Examples of the neural language model 118 may include, but are not limited to, generative pre-trained transformer models, bidirectional encoder representations from transformers models, text-to-text transfer transformer models, large language models, transformer-based generators, or specialized conversational artificial intelligence models.

The user interface 120 may provide an interactive platform through which the user 122 submits search requests and receives search results from the computer system 102. The user interface 120 displays the input query 124 and the response data 126. In the illustrated example, the input query 124 shows a question “What is the revenue of Company ABC in Q3 2025?” and the response data 126 displays “Q3 2025 revenue is 1.3 million USD”. The user interface 120 may present search results, context information, and generated responses while maintaining privacy of the underlying search operations. Examples of the user interface 120 may include, but are not limited to, a web interface, a mobile application interface, a desktop application, a command-line interface, or a specialized search interface.

The communication network 128 may include suitable logic, circuitry, and interfaces configured to facilitate data exchange and communication between the computer system 102, the server 104, and the user device 106. The communication network 128 may be implemented as a wired or wireless network infrastructure that supports various communication protocols and connection types for transmitting encrypted query embeddings, search results, homomorphic computation data, and cryptographic key information between system components. In some embodiments, the communication network 128 may provide secure communication channels that protect sensitive encrypted embedding data during transmission while enabling real-time interaction between the homomorphic operation module 110 and the hybrid search index structure 108. The communication network 128 may support multiple concurrent connections and data streams to enable simultaneous encrypted search operations across different vector databases. The communication network 128 may implement quality of service mechanisms that prioritize critical encrypted search communications and ensure reliable delivery of encrypted query embeddings and similarity computation results during homomorphic search sessions. The communication network 128 may include network security features such as encryption, authentication, and access control mechanisms to prevent unauthorized access to encrypted embedding search operations and protect the integrity of privacy-preserving search processes. Examples of the communication network 128 may include, but are not limited to, a local area network (LAN), a wide area network (WAN), the Internet, a wireless local area network (WLAN), a cellular network, a satellite communication network, a virtual private network (VPN), a software-defined network (SDN), a cloud-based network infrastructure, or a hybrid network combining multiple communication technologies and protocols.

In operation, the computer system 102 may receive an input query 124 from the user device 106 through the communication network 128. The embedding model 116 processes the input query 124 to generate a query embedding vector that captures the semantic meaning of the input query 124 through high-dimensional numerical representations. For example, a natural language query such as “What is the revenue of Company ABC in Q3 2025?” may be transformed into a 768-dimensional vector representation that encodes the semantic content of the query. The query embedding vector is then encrypted using a homomorphic encryption scheme to produce an encrypted query embedding comprising ciphertexts corresponding to elements of the query embedding vector. The encryption of the query embedding vector may be performed on the user device 106 for enhanced client-side privacy, where the user device 106 maintains local cryptographic keys and performs encryption operations before transmitting the encrypted query embedding over the communication network 128. Alternatively, the encryption may be performed on the computer system 102, where the query embedding vector is transmitted from the user device 106 and encrypted using cryptographic keys maintained by the computer system 102. Each ciphertext is generated using a homomorphic encryption scheme selected based on a data type of the elements in the embedding vector, such as CKKS scheme for floating-point operations, BFV scheme for integer operations, BGV scheme for general computations, TFHE scheme for Boolean operations, RLWE scheme, or Gaussian-based schemes (GMEW). The encryption process utilizes public keys generated by sampling discrete Gaussian distributions over a polynomial ring, where the public key and a secret key are generated based on the Ring Learning with Errors problem to ensure cryptographic security.

Once the encrypted query embedding is prepared, the computer system 102 initiates a search process to identify the most similar encrypted embeddings from the hybrid search index structure 108. The hybrid search index structure 108 contains a collection of encrypted embeddings that have been preprocessed through a normalization and transformation pipeline including normalizing each embedding vector to unit length, applying scaling transformations based on specific scaling factors, and adding randomization factors from multivariate normal distributions to optimize the vectors for homomorphic encryption and reduce ciphertext expansion. The preprocessed encrypted embeddings are organized to enable similarity search operations while maintaining complete data confidentiality. The search process leverages the hierarchical organization of the hybrid search index structure 108 to progressively narrow down the search space and identify the most relevant candidate nodes without requiring decryption of any encrypted embedding.

The computer system 102 may traverse the hybrid search index structure 108 comprising the NSW graph 108a, which may be implemented as a Hierarchical Navigable Small World (HNSW) graph, to identify a set of candidate nodes from a plurality of nodes of the hybrid search index structure 108. Each node of the plurality of nodes is associated with an encrypted embedding of a plurality of encrypted embeddings. The encrypted embedding comprises ciphertexts corresponding to elements of an embedding vector of a plurality of embedding vectors. The NSW graph 108a comprises the plurality of nodes and edges between the plurality of nodes, with connectivity information for the edges maintained in plaintext to enable efficient graph traversal while the encrypted embeddings remain protected. In the case of an HNSW graph, the plurality of nodes is spread across hierarchical levels of the HNSW graph, and the traversal of the hybrid search index structure 108 is performed as a progressive traversal across the hierarchical levels of the HNSW graph to identify the set of candidate nodes. For example, the traversal may begin at the highest level with a specific number of nodes and progressively move to lower levels with increasing node density until reaching the base level containing all nodes. The homomorphic operation module 110 may perform homomorphic similarity computations between the encrypted query embedding and the encrypted embedding associated with each candidate node of the set of candidate nodes through homomorphic dot product operations. Each homomorphic dot product operation comprises element-wise homomorphic multiplication between ciphertexts of the encrypted query embedding and ciphertexts of the encrypted embedding to generate multiplication results, re-linearization of each multiplication result based on evaluation keys to generate re-linearized multiplication results, and homomorphic addition of the re-linearized multiplication results to generate a respective similarity score of similarity scores. The evaluation keys are generated based on sampling discrete Gaussian distributions over a polynomial ring and enable efficient management of ciphertext size and noise growth during homomorphic operations. The identification of the set of candidate nodes is performed without a decryption of the ciphertexts of the encrypted embedding and ciphertexts of the encrypted query embedding, ensuring complete privacy preservation throughout the search process. Each homomorphic similarity computation is performed during the traversal at a respective candidate node of the set of candidate nodes, and the traversal is based on a priority queue of the set of candidate nodes ordered by the similarity scores. The computer system 102 supports various distance metrics including homomorphic versions of dot product, Euclidean distance, or Hamming distance to accommodate different similarity measurement requirements.

In some embodiments, the computer system 102 may identify, from the plurality of encrypted embeddings, a set of encrypted embeddings similar to the encrypted query embedding based on the similarity scores, and apply a homomorphic decryption scheme to the identified set of encrypted embeddings to generate a set of decrypted embedding vectors. The homomorphic decryption scheme comprises applying a secret key or a derived secret key to the identified set of encrypted embeddings. The secret key is based on sampling discrete Gaussian distributions over a polynomial ring and is generated along with the public key and the evaluation keys. The decryption of the encrypted embedding vectors may be performed on the computer system 102, where the computer system 102 maintains the secret keys and performs homomorphic decryption operations to generate the set of decrypted embedding vectors for subsequent processing. Alternatively, the decryption may be performed on the user device 106, where the identified set of encrypted embeddings is transmitted to the user device 106 and decrypted using secret keys or derived secret keys maintained locally on the user device 106.

The computer system 102 implements advanced key management architectures to support multi-tenant deployments and role-based access control, utilizing index-level secret keys as master keys for database or index-level encryption, with individual user keys derived from the master secret to enable selective access to encrypted embeddings. The derived secret key may be generated from the master secret key to enable selective access to encrypted data in multi-tenant deployments, allowing different users to decrypt only authorized results while maintaining complete privacy of unauthorized embedding data.

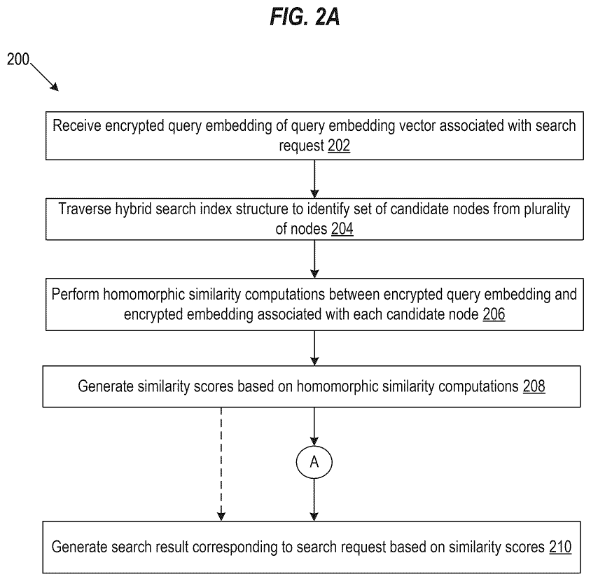

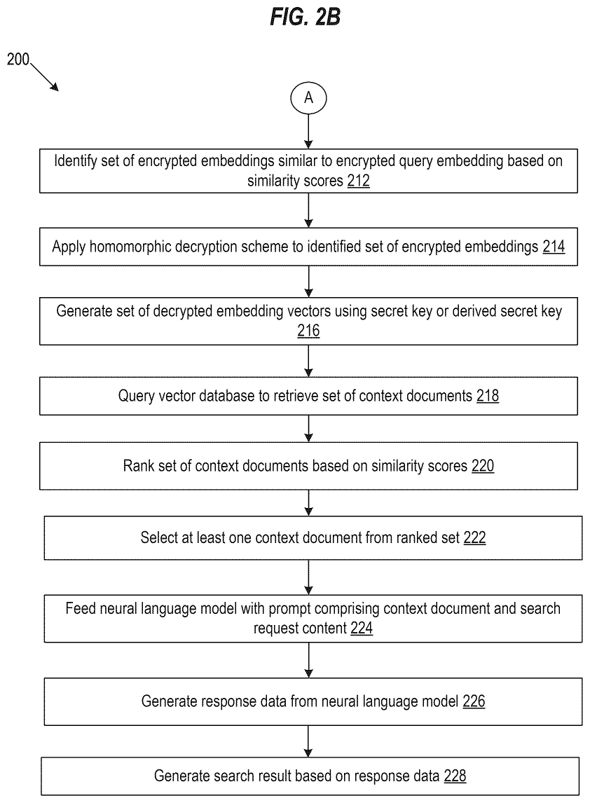

In certain embodiments, the computer system 102 may query the vector database 114 to retrieve a set of context documents associated with the set of decrypted embedding vectors, and generate a search result corresponding to a search request further based on the set of context documents. For example, if the original query was about company revenue, the retrieved context documents may include financial reports, earnings statements, business analytics documents, portions thereof that contain information relevant to the original query. The set of context documents may be ranked based on the similarity scores, with at least one context document (e.g., top-k documents) selected from the ranked set of context documents. The neural language model 118 may be fed with a prompt comprising the at least one context document and content of the search request to generate response data 126, which is then used to generate the search result. For instance, the neural language model 118 may process a prompt containing the selected financial documents and the original query to generate a response such as “Q3 2025 revenue is 1.3 million USD” as shown in the response data 126 displayed on the user interface 120 for the user 122. The approach enables privacy-preserving retrieval-augmented generation applications where sensitive proprietary data, private cloud storage content, or confidential information in regulated industries such as healthcare, finance, and legal services remains encrypted throughout the search process while still providing accurate and contextually relevant responses. The computer system 102 may be implemented through a software development kit (SDK) layer that transparently intercepts vector database operations, enabling integration with existing vector databases such as distributed vector databases, cloud-based vector search services, and relational databases with vector extensions, and supports various distance metrics through homomorphic implementations. Further details related to the encrypted search operations are provided in FIGS. 2A and 2B, FIG. 4, and FIG. 5.

FIGS. 2A and 2B are diagrams that illustrate a flowchart 200 depicting an encrypted embedding search process in a retrieval-augmented generation system, in accordance with an embodiment of the disclosure. FIGS. 2A and 2B are explained in conjunction with elements from FIG. 1. With reference to FIGS. 2A and 2B, there is shown the flowchart 200. The operations of the exemplary method may be executed by any computing system, for example, by the computer system 102 of FIG. 1. The operations of the flowchart 200 may start at 202.

At 202, the operations include receiving an encrypted query embedding of a query embedding vector associated with a search request. In an embodiment of the disclosure, the computer system 102 is configured to receive the encrypted query embedding from the user device 106 through the communication network 128. The encrypted query embedding comprises ciphertexts corresponding to elements of the query embedding vector. The encrypted query embedding may be denoted as c_{q}=[c_{q,1}, c_{q,2}, . . . , c_{q,n}], where each c_{q,i} represents a ciphertext corresponding to the i-th element of the query embedding vector v_{q}=[v_{q,1}, v_{q,2}, . . . , v_{q,n}]. The encrypted query embedding may be generated by processing the input query 124 through the embedding model 116 to create a query embedding vector, which is then encrypted using a homomorphic encryption scheme selected based on a data type of the elements in the embedding vector. The input query 124 may comprise unimodal data including text queries, image data, audio signals, video content, or sensor data, or multimodal data combining multiple modalities such as text-image pairs, audio-visual content, or text-audio combinations. For text modalities, the embedding model 116 may utilize transformer-based architectures such as BERT or GPT models to generate semantic embeddings. For image modalities, the embedding model 116 may employ convolutional neural networks or vision transformers to extract visual feature representations. For audio modalities, the embedding model 116 may use mel-spectrogram analysis or neural audio encoders to generate acoustic embeddings. For multimodal inputs, the embedding model 116 may implement cross-modal attention mechanisms or joint embedding spaces that capture relationships between different modalities. The homomorphic encryption scheme comprises at least one of CKKS scheme for floating-point operations, BFV scheme for integer operations, BGV scheme for general computations, TFHE scheme for Boolean operations, RLWE scheme for various applications, or GMEW for specialized applications. The encryption process utilizes public keys pk=(a, b) generated by sampling discrete Gaussian distributions over a polynomial ring, with secret key sk=s, ensuring cryptographic security based on the Ring Learning with Errors problem. For example, a natural language query such as “What is the revenue of Company ABC in Q3 2025?” may be transformed into a 768-dimensional vector representation that encodes the semantic content of the query, while an image query of a company logo may be processed through a vision transformer to generate a 512-dimensional visual embedding, with each element encrypted as a ciphertext cᵢ=(c_{0,i}, c_{1,i}).

At 204, the operations include traversing a hybrid search index structure to identify a set of candidate nodes from a plurality of nodes. In an embodiment of the disclosure, the computer system 102 is configured to traverse the hybrid search index structure 108 comprising the NSW graph 108a to identify the set of candidate nodes C={n₁, n₂, . . . , nₖ} from the plurality of nodes N={n₁, n₂, . . . , n_{N}} of the hybrid search index structure 108. Each node nᵢ of the plurality of nodes is associated with an encrypted embedding cᵢ=[c_{i,1}, c_{i,2}, . . . , c_{i,d}] of a plurality of encrypted embeddings. The encrypted embedding comprises ciphertexts c_{i,j}=(c_{0,i,j}, c_{1,i,j}) corresponding to elements v_{i,j} of an embedding vector vᵢ=[v_{i,1}, v_{i,2}, . . . , v_{i,d}] of a plurality of embedding vectors. The embedding vectors may represent diverse data modalities including textual content embeddings generated from documents, articles, or natural language text, visual embeddings extracted from images, photographs, or graphical content, audio embeddings derived from speech, music, or sound recordings, video embeddings capturing temporal visual information, or multimodal embeddings that fuse information across multiple modalities such as image-text pairs or audio-visual content.

The traversal leverages the hierarchical organization of the hybrid search index structure 108. Connectivity information for edges E={e₁, e₂, . . . , eₘ} is maintained in plaintext (e.g., similarity scores between nodes) to enable efficient graph navigation while the encrypted embeddings remain protected. In cases where the NSW graph 108a is implemented as a hierarchical navigable small world (HNSW) graph, the plurality of nodes of the HNSW graph is spread across hierarchical levels L={L₀, L₁, . . . , Lₕ} of the HNSW graph, and the traversal is performed as a progressive traversal across the hierarchical levels of the HNSW graph to identify the set of candidate nodes. The traversal may begin at the highest level with a specific number of nodes and progressively move to lower levels with increasing node density until reaching the base level containing all nodes. The identification of the set of candidate nodes is performed without a decryption of the ciphertexts of the encrypted embedding and ciphertexts of the encrypted query embedding, ensuring complete privacy preservation during the traversal process.

At 206, the operations include performing homomorphic similarity computations between the encrypted query embedding and an encrypted embedding associated with each candidate node. In an embodiment of the disclosure, the homomorphic operation module 110 is configured to perform the homomorphic similarity computations through homomorphic dot product operations between the encrypted query embedding c_{q} and the encrypted embedding cᵢ associated with each respective candidate node nᵢ of the set of candidate nodes. The homomorphic similarity computations support cross-modal and intra-modal similarity calculations, enabling comparison between embeddings of the same modality (e.g., text-to-text, image-to-image, audio-to-audio) or different modalities (e.g., text-to-image, audio-to-text, image-to-video) through shared embedding spaces or learned cross-modal mappings. Each homomorphic dot product operation comprises element-wise homomorphic multiplication between ciphertexts c_{q,j} of the encrypted query embedding and ciphertexts c_{i,j} of the encrypted embedding to generate multiplication results mⱼ=HomMult(c_{q,j}, c_{i,j}), re-linearization of each multiplication result based on evaluation keys evk to generate re-linearized multiplication results m′ⱼ=Relinearize(mⱼ, evk), and homomorphic addition of the re-linearized multiplication results to compute the similarity score sᵢ=Σⱼ₌₁^{d} m′ⱼ. The evaluation keys evk are generated based on sampling discrete Gaussian distributions over a polynomial ring and enable efficient management of ciphertext size and noise growth during homomorphic operations. The re-linearization operation is a critical cryptographic procedure that reduces the degree of ciphertexts after homomorphic multiplication, transforming a three-element ciphertext (c₀, c₁, c₂) back to a two-element form (c₀′, c₁′) to maintain computational efficiency and control noise growth. The re-linearization process parses the multiplication result c=(c₀, c₁, c₂) where c₂ is the quadratic component resulting from ciphertext multiplication, decomposes c₂ into its binary representation as

$${c}_{2} = {\sum }_{i = 0}^{⌊ {log}_{2} q ⌋} {2}^{i} \cdot {c}_{2 , i} ,$$

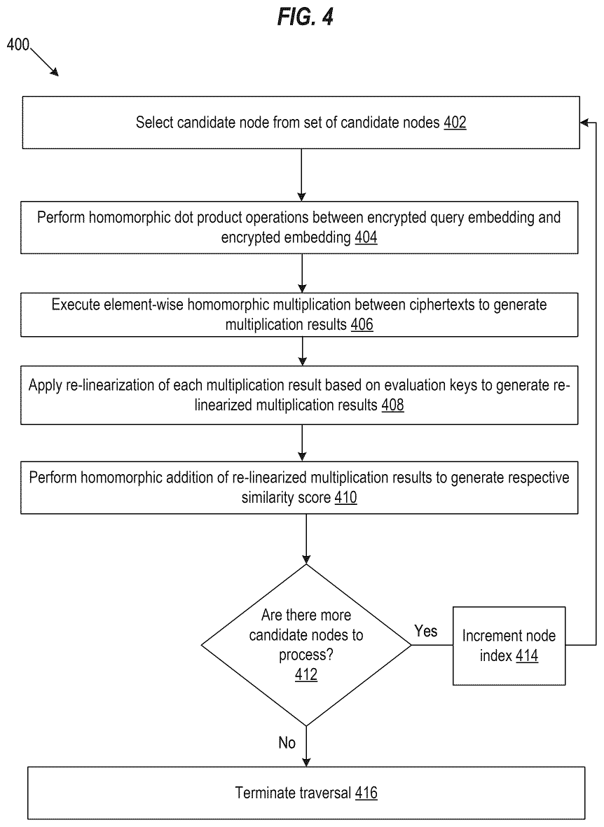

and computes the relinearized components

$${c}_{0}^{′} = {c}_{0} + {\sum }_{i = 0}^{⌊ {log}_{2} q ⌋} {2}^{i} \cdot ( {rlk}_{0 , i} \cdot {c}_{2 , i} ) mod q and {c}_{1}^{′} = {c}_{1} + {\sum }_{i = 0}^{⌊ {log}_{2} q ⌋} {2}^{i} \cdot ( {rlk}_{1 , i} \cdot {c}_{2 , i} ) mod q ,$$

where rlk_{0,i} and rlk_{1,i} are components of the relinearization keys derived from the evaluation keys. The re-linearization operation is essential for preventing exponential growth in ciphertext size during deep homomorphic computations and enables the computer system 102 to perform multiple sequential multiplication operations without requiring frequent bootstrapping procedures. Further details related to these operations are provided in FIG. 4, for example.

The homomorphic operation module 110 supports various distance metrics including homomorphic versions of dot product, Euclidean distance, and Hamming distance to accommodate different similarity measurement requirements across diverse data modalities. The homomorphic operations utilize advanced preprocessing techniques including vector normalization, scaling transformations, and randomization factors to reduce ciphertext expansion by 85-90%, significantly extending the feasibility of encrypted computations.

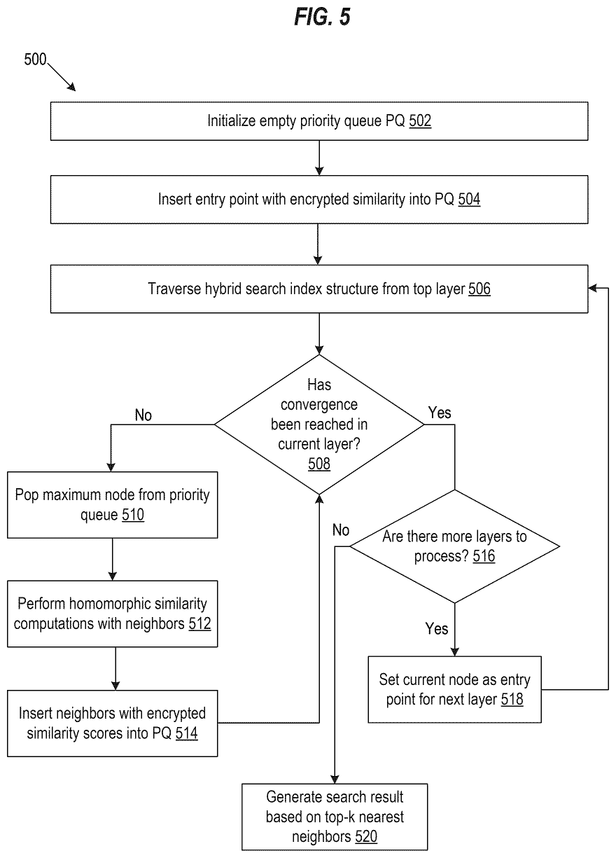

At 208, the operations include generating similarity scores based on the homomorphic similarity computations. In an embodiment of the disclosure, each homomorphic similarity computation generates a respective similarity score sᵢ of the similarity scores S={s₁, s₂, . . . , sₖ} through the homomorphic addition of the re-linearized multiplication results. Each of the similarity scores may be referred to as an encrypted similarity score comprising ciphertexts in the format (c₀, c₁). The encrypted similarity scores enable ranking and comparison of encrypted embeddings without requiring decryption of the underlying data, supporting both unimodal similarity assessment within the same data type and cross-modal similarity evaluation between different modalities such as matching text queries to relevant images or finding audio content similar to textual descriptions. In some embodiments, the encrypted similarity scores may be homomorphically decrypted at the user device 106 or the computer system 102 to obtain plaintext similarity values for ranking purposes as described at 220. Each homomorphic similarity computation is performed during the traversal at a respective candidate node nᵢ of the set of candidate nodes, and the traversal is based on a priority queue PQ of the set of candidate nodes ordered by the similarity scores, as described in FIG. 5, for example. The identification of the set of candidate nodes is performed without a decryption of the ciphertexts c_{i,j} of the encrypted embedding and ciphertexts c_{q,j} of the encrypted query embedding, ensuring complete privacy preservation throughout the search process. The computer system 102 implements advanced noise management techniques that significantly reduce the frequency of expensive bootstrapping operations, with bootstrapping required after only about 15% of queries compared to over 50% for traditional FHE systems.

At 210, the operations include generating a search result corresponding to the search request based on the similarity scores. In an embodiment of the disclosure, the computer system 102 is configured to generate the search result by utilizing the similarity scores S={s₁, s₂, . . . , sₖ} to identify the most relevant encrypted embeddings from the hybrid search index structure 108. The search result may contain various types of data depending on the processing stage, including at least one of: the encrypted similarity scores generated at 208 for ranking candidate nodes or decrypted similarity scores, decrypted embedding vectors generated at 216 through homomorphic decryption, context documents retrieved at from the vector database, ranked context documents processed at 220 based on the similarity scores, or response data generated at 226 by the neural language model 118 when integrated with retrieval-augmented generation workflows.

The search result generation process maintains privacy of the underlying embedding data while providing meaningful results for subsequent processing steps in the retrieval-augmented generation workflow, supporting diverse content types including textual documents, image collections, audio recordings, video content, or multimodal datasets that combine multiple data modalities. The computer system 102 achieves sublinear search complexity while maintaining complete privacy of the underlying embedding data through homomorphic encryption, with search latencies that are orders of magnitude faster than linear encrypted search methods while maintaining stronger security guarantees than partially homomorphic approaches.

Operations from 212 to 228 may be performed before or after the operation at 210. For instance, the operations from 212 to 228 may be performed after the operation at 208 to refine the search result corresponding to the search request. In some instances, an Artificial Intelligent (AI) agent system (not shown) of the computer system 102 may selectively execute the operations from 212 to 228 to refine the search result at 210. In some cases, the operations from 212 to 228 may be bypassed entirely when the encrypted similarity scores at 208 provide sufficient information for the search result at 210, enabling more efficient processing for queries that do not require contextual augmentation or natural language response generation.

At 212, the operations include identifying a set of encrypted embeddings similar to the encrypted query embedding based on the similarity scores. In an embodiment of the disclosure, the computer system 102 is configured to identify, from the plurality of encrypted embeddings {c₁, c₂, . . . , c_{N}}, the set of encrypted embeddings Cₛᵢₘᵢₗₐᵣ={cᵢ₁, cᵢ₂, . . . , cᵢₖ} similar to the encrypted query embedding c_{q} based on the similarity scores generated through the homomorphic similarity computations. The identification process selects the most relevant encrypted embeddings that exhibit high similarity to the encrypted query embedding, enabling targeted retrieval of contextually relevant information across various data modalities.

At 214, the operations include applying a homomorphic decryption scheme to the identified set of encrypted embeddings. In an embodiment of the disclosure, the computer system 102 is configured to apply the homomorphic decryption scheme to the identified set of encrypted embeddings Cₛᵢₘᵢₗₐᵣ to enable access to the underlying embedding vectors for subsequent document retrieval operations. The homomorphic decryption scheme comprises applying a secret key sk=s or a derived secret key sk′ to the identified set of encrypted embeddings. The secret key is based on sampling discrete Gaussian distributions over a polynomial ring. The computer system 102 implements advanced key management architectures to support multi-tenant deployments and role-based access control, utilizing index-level secret keys skₘₐₛₜₑᵣ as master keys for database or index-level encryption, with individual user keys skᵤₛₑᵣ derived from the master secret to enable selective access to encrypted data. The derived secret key sk′ may be generated from a master secret key skₘₐₛₜₑᵣ to enable selective access to encrypted data in multi-tenant deployments, allowing different users to decrypt only authorized results while maintaining complete privacy of unauthorized data. The derived keys include access permissions and enable client-side decryption of authorized results while maintaining complete privacy of unauthorized data.

At 216, the operations include generating a set of decrypted embedding vectors using a secret key or derived secret key. In an embodiment of the disclosure, the computer system 102 is configured to generate the set of decrypted embedding vectors V_{decrypted}={vᵢ₁, vᵢ₂, . . . , vᵢₖ} through the application of the secret key sk or derived secret key sk′ to the identified set of encrypted embeddings Cₛᵢₘᵢₗₐᵣ. The decryption process enables access to the plaintext embedding vectors that correspond to the most similar encrypted embeddings identified during the search process at 212, facilitating subsequent document retrieval operations from the vector database 114. The decrypted embedding vectors may represent various data modalities including textual semantic embeddings, visual feature vectors from images or videos, acoustic representations from audio content, or multimodal vectors that combine information from multiple modalities. The decryption of the encrypted embedding vectors may be performed on the computer system 102, where the computer system 102 maintains the secret keys and performs decryption operations to generate the set of decrypted embedding vectors for subsequent processing. Alternatively, the decryption may be performed on the user device 106, where the identified set of encrypted embeddings is transmitted to the user device 106 and decrypted using secret keys or derived secret keys maintained locally on the user device 106.

At 218, the operations include querying a vector database to retrieve a set of context documents. In an embodiment of the disclosure, the computer system 102 is configured to query the vector database 114 to retrieve the set of context documents D_{context}={d₁, d₂, . . . , dₖ} associated with the set of decrypted embedding vectors V_{decrypted}. The vector database 114 maintains associations between embedding vectors vᵢ and corresponding documents dᵢ or chunks thereof stored in the document store 112, enabling efficient retrieval of relevant content based on the decrypted embedding vectors. The decrypted embedding vectors may correspond to entire context documents or to specific chunks or segments of the context documents, allowing for granular retrieval of relevant content portions. The context documents may comprise diverse content types including textual documents such as articles, reports, or research papers, image files containing photographs, diagrams, or illustrations, audio files including speech recordings, music, or sound effects, video content with visual and temporal information, or multimodal documents that combine multiple data types such as presentations with text and images or multimedia articles with embedded audio and video content. For example, if the original query was about company revenue, the retrieved context documents may include financial reports, earnings statements, or business analytics documents that contain relevant information, while an image query about a product might retrieve product catalogs, technical specifications, or marketing materials containing relevant visual and textual information.

At 220, the operations include ranking a set of context documents based on similarity scores. In an embodiment of the disclosure, the computer system 102 is configured to rank the set of context documents D_{context} retrieved from the vector database 114 based on the similarity scores S={s₁, s₂, . . . , sₖ} obtained from the encrypted similarity scores generated during the homomorphic similarity computations. The similarity scores may be used in encrypted form as ciphertexts (c₀, c₁) for privacy-preserving ranking operations or may be decrypted to obtain floating-point values for conventional ranking purposes. For example, when using decrypted similarity scores, the scores may be ranked in descending order such as s₁=0.92, s₂=0.87, s₃=0.81, s₄=0.76, s₅=0.73, where higher scores indicate greater similarity between the encrypted query embedding and the encrypted embeddings associated with the context documents. Alternatively, when using encrypted similarity scores, homomorphic comparison operations may be performed to maintain privacy throughout the ranking process. The ranking process enables prioritization of the most relevant context documents for subsequent processing by the neural language model 118, ensuring that the most contextually appropriate information is utilized for response generation across different modalities and content types. The set of context documents may be ranked based on the similarity scores, with at least one context document d_{selected} selected from the ranked set of context documents for further processing.

At 222, the operations include selecting at least one context document from the ranked set. In an embodiment of the disclosure, the computer system 102 is configured to select the at least one context document d_{selected} from the ranked set of context documents D_{ranked} based on relevance criteria, similarity scores (whether encrypted or decrypted), or other selection parameters. The selection process ensures that the most appropriate contextual information is provided to the neural language model 118 for generating accurate and relevant responses to the search request, considering the modality and content type of both the original query and the retrieved documents. The selection may involve choosing the top-ranked documents or applying additional filtering criteria to identify the most contextually relevant information for the specific search request, including modality-specific relevance assessments for cross-modal queries. For example, in a top-k selection approach, the computer system 102 may select the top-3 documents with the highest similarity scores from a ranked list of 100 retrieved documents or select the top-5 documents that exceed a predetermined similarity threshold of 0.85, ensuring that only the most relevant contextual information is used for response generation while maintaining computational efficiency.

At 224, the operations include feeding a neural language model with a prompt comprising the context document and search request content. In an embodiment of the disclosure, the computer system 102 is configured to feed the neural language model 118 with a prompt P=[d_{selected}, q_{content}] comprising the at least one context document d_{selected} selected from the ranked set and content q_{content} of the search request to enable contextually aware response generation. The neural language model 118 processes the combined prompt to understand the relationship between the search request and the retrieved contextual information, enabling generation of accurate and relevant responses across different modalities and content types. The neural language model 118 may include large language models, transformer-based text generators, autoregressive language models, or multi-modal artificial intelligence systems, which can understand and generate human-like text or multimodal content based on the input the neural language model 118 receives, including multimodal models capable of processing and reasoning about text, images, audio, and video content simultaneously.

At 226, the operations include generating response data from the neural language model. In an embodiment of the disclosure, the neural language model 118 is configured to generate the response data R=f(P) based on the prompt P comprising the at least one context document and content of the search request. The response data 126 represents the neural language model's interpretation and synthesis of the contextual information in relation to the original search request. For example, the neural language model 118 may process a prompt containing the selected financial documents and the original query to generate a response such as “Q3 2025 revenue is 1.3 Million USD” as shown in the response data 126 displayed on the user interface 120 for the user 122, or the neural language model 118 may generate descriptions of visual content when processing image-based queries with textual context documents. The neural language model 118 may be configured to handle multilingual content, recognizing and processing content in different spoken languages.

At 228, the operations include generating a search result based on the response data. In an embodiment of the disclosure, the computer system 102 is configured to generate the final search result based on the response data generated by the neural language model 118. The computer system 102 may further transmit the search result to the user device 106 through the communication network 128 for displaying the search result on the user interface 120, enabling the user 122 to access relevant information while maintaining complete privacy of the underlying data throughout the entire retrieval-augmented generation process, supporting presentation of results in formats appropriate to the original query modality and retrieved content types.

Modifications may be made to the operations from 202 to 228 without departing from the scope of the disclosure, including parallel execution of multiple operations, conditional branching based on similarity score thresholds, or adaptive selection of processing paths based on query characteristics or system performance requirements. The AI agent system may implement decision logic that determines whether to proceed with retrieval-augmented generation based on factors such as the quality of encrypted similarity scores, the availability of relevant context documents, or user-specified preferences for response generation versus direct search results.

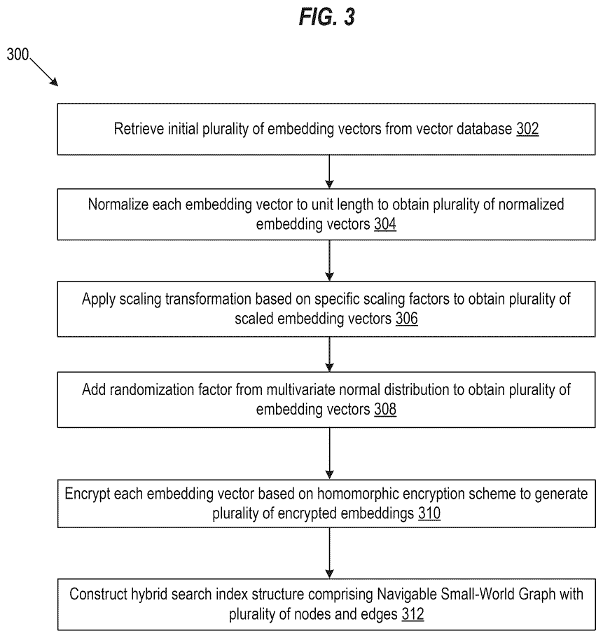

FIG. 3 is a diagram that illustrates a flowchart 300 for constructing a hybrid search index structure with encrypted embeddings, in accordance with an embodiment of the disclosure. FIG. 3 is explained in conjunction with elements from FIG. 1 and FIGS. 2A and 2B. With reference to FIG. 3, there is shown the flowchart 300. The operations of the exemplary method may be executed by any computing system, for example, by the computer system 102 of FIG. 1. The operations of the flowchart 300 may start at 302.

At 302, the operations include retrieving an initial plurality of embedding vectors from a vector database. In an embodiment of the disclosure, the computer system 102 is configured to retrieve the initial plurality of embedding vectors Vᵢₙᵢₜᵢₐₗ={v₁, v₂, . . . , v_{N}} from the vector database 114. Each embedding vector vᵢ=[v_{i,1}, v_{i,2}, . . . , v_{i,d}] may represent high-dimensional numerical representations of various data types including textual content, visual features, audio characteristics, or multimodal information. The initial plurality of embedding vectors may be generated by the embedding model 116 from diverse data sources including documents stored in the document store 112, image collections, audio recordings, or other content types. The retrieval process establishes a foundation for subsequent preprocessing and encryption operations.

At 304, the operations include normalizing each embedding vector to unit length to obtain a plurality of normalized embedding vectors. In an embodiment of the disclosure, the computer system 102 is configured to normalize each embedding vector vᵢ of the initial plurality of embedding vectors to unit length through the computation v_{norm,i}=vᵢ/∥vᵢ∥₂ to obtain a plurality of normalized embedding vectors Vₙₒᵣₘ={v_{norm,1}, v_{norm,2}, . . . , v_{norm,N}}. The normalization process ensures that each embedding vector has a Euclidean norm of 1, which provides consistent similarity calculations in the encrypted domain and reduces the dynamic range of values that must be encrypted. The normalization operation may be particularly beneficial for homomorphic dot product computations, as the normalized vectors enable more stable noise growth characteristics during subsequent homomorphic operations.

At 306, the operations include applying a scaling transformation based on specific scaling factors to obtain a plurality of scaled embedding vectors. In an embodiment of the disclosure, the computer system 102 is configured to apply a scaling transformation based on specific scaling factors sⱼ to each normalized embedding vector v_{norm,i} of the plurality of normalized embedding vectors to obtain a plurality of scaled embedding vectors V_{scaled}={v_{scaled,1}, v_{scaled,2}, . . . , v_{scaled,N}}. The scaling transformation may be computed as v_{scaled,i}=[s₁×v_{norm,i,1}, s₂×v_{norm,i,2}, . . . , s_{d}×v_{norm,i,d}], where each scaling factor sⱼ is selected to optimize the dynamic range of encrypted values and reduce noise accumulation during homomorphic operations. The scaling factors may be determined based on characteristics of the homomorphic encryption scheme and expected range of similarity computations.

At 308, the operations include adding a randomization factor from a multivariate normal distribution to obtain the plurality of embedding vectors. In an embodiment of the disclosure, the computer system 102 is configured to add a randomization factor λᵢ from a multivariate normal distribution to each scaled embedding vector v_{scaled,i} of the plurality of scaled embedding vectors to obtain the plurality of embedding vectors V_{final}={v_{final,1}, v_{final,2}, . . . , v_{final,N}}. As an example, the randomization factor λᵢ may be computed as λᵢ=uᵢ×(sβ/4)×(x′)^{1/n} /∥uᵢ∥₂, where uᵢ~N(0, I_{d}) is a normal random vector, s represents the scaling factor, β represents an approximation factor, and x′~U(0,1) is a uniform scalar. The randomization process provides an additional security layer with controlled noise while maintaining the semantic relationships between embedding vectors.

At 310, the operations include encrypting each embedding vector based on a homomorphic encryption scheme to generate a plurality of encrypted embeddings. In an embodiment of the disclosure, the computer system 102 is configured to encrypt each embedding vector v_{final,i} of the plurality of embedding vectors based on a homomorphic encryption scheme to generate a plurality of encrypted embeddings C={c₁, c₂, . . . , c_{N}}. The plurality of encrypted embeddings comprises the encrypted embedding cᵢ of each embedding vector v_{final,i} of the plurality of embedding vectors. The homomorphic encryption scheme may be selected based on a data type of the elements in the embedding vector and supports multiple FHE schemes including, but not limited to, CKKS scheme, BFV scheme, BGV scheme, TFHE scheme, RLWE scheme, and GMEW.

The computer system 102 may sample discrete Gaussian distributions over a polynomial ring to generate a public key pk=(a, b) and a secret key sk=s, where the public key is used to encrypt the plurality of embedding vectors to generate the plurality of encrypted embeddings. By way of example, and not limitation, the keys may be generated using a key generation process, which involves choosing a ring dimension

$$n = {2}^{⌈ {log}_{2} λ ⌉}$$

where λ is the security parameter, selecting a modulus

$$q = NextPrime ( {2}^{⌊ {log}_{2} λ ⌋} )$$

which determines the ciphertext size and noise tolerance, sampling the secret key s←D_{Z,σkey}ⁿ from a discrete Gaussian distribution with standard deviation σ_{key}, sampling a random polynomial a←U(R_{q}) from a uniform distribution over the ring R_{q}, sampling error e←D_{Z,σerr}ⁿ to add noise for security, computing the public key component b=−(a·s+e) mod q, and generating evaluation keys evk=(rlk₀, rlk₁)=(Encrypt(s²), Encrypt(−s)) for relinearization operations. Each encrypted embedding cᵢ=[c_{i,1}, c_{i,2}, . . . , c_{i,d}] comprises ciphertexts c_{i,j}=(c_{0,i,j}, c_{1,i,j}) corresponding to elements v_{final,i,j} of the embedding vector v_{final,i}, with each ciphertext represented as a polynomial over a ring. In an example scenario, the preprocessing pipeline achieves about 85-90% reduction in ciphertext expansion through the normalization and transformation techniques described from 302 to 308, extending the feasibility of encrypted computations and enabling practical deployment on traditional hardware without requiring specialized accelerators.

At 312, the operations include constructing the hybrid search index structure comprising a Navigable Small-World Graph with a plurality of nodes and edges. In an embodiment of the disclosure, the computer system 102 is configured to construct the hybrid search index structure 108 comprising the NSW graph 108a. The NSW graph 108a comprises the plurality of nodes N={n₁, n₂, . . . , n_{N}} and edges E={e₁, e₂, . . . , eₘ} between the plurality of nodes. Each node nᵢ of the plurality of nodes is associated with an encrypted embedding cᵢ from the plurality of encrypted embeddings generated at 310. Connectivity information for the edges is maintained in plaintext to enable efficient graph navigation while the encrypted embeddings remain protected, providing a hybrid approach that combines the security benefits of fully homomorphic encryption with the efficiency of approximate nearest neighbor search algorithms.

In an embodiment, the NSW graph 108a may be implemented as a HNSW graph with multiple hierarchical levels, where the plurality of nodes is distributed across different levels to enable progressive traversal during search operations. The construction process establishes the graph topology based on proximity relationships (e.g., cosine distance score) between the embedding vectors while maintaining complete privacy of the underlying data through encryption of the embedding vectors.

FIG. 4 is a diagram that illustrates a flowchart 400 for an encrypted search process using homomorphic similarity computations, in accordance with an embodiment of the disclosure. FIG. 4 is explained in conjunction with elements from FIG. 1, FIGS. 2A and 2B, and FIG. 3. With reference to FIG. 4, there is shown the flowchart 400. The operations of the exemplary method may be executed by any computing system, for example, by the computer system 102 of FIG. 1. The operations of the flowchart 400 may start at 402.

At 402, the operations include selecting a candidate node from a set of candidate nodes. In an embodiment of the disclosure, the computer system 102 is configured to select a candidate node ni from the set of candidate nodes C={n₁, n₂, . . . , nₖ} identified during traversal of the hybrid search index structure 108, as described in FIG. 2A. Each candidate node ni is associated with an encrypted embedding cᵢ=[c_{i,1}, c_{i,2}, . . . , c_{i,d}] comprising ciphertexts corresponding to elements of an embedding vector. The selection process enables systematic processing of each candidate node to compute similarity scores through homomorphic operations while maintaining complete privacy of the underlying embedding data.

At 404, the operations include performing homomorphic dot product operations between an encrypted query embedding and an encrypted embedding. In an embodiment of the disclosure, the homomorphic operation module 110 is configured to perform homomorphic dot product operations between the encrypted query embedding c_{q}=[c_{q,1}, c_{q,2}, . . . , c_{q,d}] and the encrypted embedding cᵢ=[c_{i,1}, c_{i,2}, . . . , c_{i,d}] associated with each respective candidate node of the set of candidate nodes. The homomorphic dot product operations initialize cₛᵤₘ=Encrypt(0) as a ciphertext representing the sum initialized to zero, then for each component j of the vectors, compute cₘᵤₗₜ=HomMult(c_{q}[j], cᵢ[j], evk) as the product of the j-th components of the vectors, and add cₘᵤₗₜ to the running total through cₛᵤₘ=HomAdd(cₛᵤₘ, cₘᵤₗₜ), returning the final dot product cₛᵤₘ which is the sum of all element-wise products. The homomorphic dot product operations enable computation of similarity measures directly on encrypted data without requiring decryption, maintaining privacy throughout the similarity computation process.

At 406, the operations include executing element-wise homomorphic multiplication between ciphertexts to generate multiplication results. In an embodiment of the disclosure, each of the homomorphic dot product operations comprises an element-wise homomorphic multiplication between ciphertexts c_{q,j} of the encrypted query embedding and the ciphertexts c_{i,j} of the encrypted embedding to generate multiplication results mⱼ=HomMult(c_{q,j}, c_{i,j}) for j=1, 2, . . . , d. The homomorphic multiplication parses c=(c₀, c₁) and c′=(c₀′, c₁′), computes intermediate products d₀=c₀·c₀′ mod q as the product of the first ciphertext components, d₁=c₀·c₁′+c₁·c₀′ mod q as the cross terms of the components, and d₂=c₁·c₁′ mod q as the product of the second ciphertext components, then re-linearizes the result as cₘᵤₗₜ=Relinearize((d₀, d₁, d₂), evk) to reduce the size of the resulting ciphertext. The multiplication results mj are then passed to operation at 408 for re-linearization processing. The element-wise homomorphic multiplication operations are performed across all dimensions of the encrypted embeddings, enabling computation of the dot product components while preserving the encrypted nature of the underlying data. The multiplication results maintain the homomorphic properties necessary for subsequent re-linearization and addition operations, ensuring that the similarity computation can proceed entirely in the encrypted domain.

At 408, the operations include applying re-linearization of each multiplication result based on evaluation keys to generate re-linearized multiplication results. In an embodiment of the disclosure, a re-linearization of each of the multiplication results mj is applied based on evaluation keys evk to generate re-linearized multiplication results m′ⱼ=Relinearize(mⱼ, evk). The re-linearization process parses c=(d₀, d₁, d₂) where d₂ is the result of ciphertext multiplication, decomposes d₂ into its binary representation as

$${d}_{2} = {\sum }_{i = 0}^{⌊ {log}_{2} q ⌋} {2}^{i} \cdot {d}_{2 , i} ,$$

computes

$${c}_{0}^{′} = {d}_{0} + {\sum }_{i = 0}^{⌊ {log}_{2} q ⌋} {2}^{i} \cdot ( {rlk}_{0 , i} \cdot {d}_{2 , i} ) mod q$$

and

$${c}_{1}^{′} = {d}_{1} + {\sum }_{i = 0}^{⌊ {log}_{2} q ⌋} {2}^{i} \cdot ( {rlk}_{1 , i} \cdot {d}_{2 , i} ) mod q ,$$

and returns the relinearized ciphertext cᵣₑₗᵢₙ=(c₀′, c₁′). The evaluation keys evk are based on a sampling of discrete Gaussian distributions over a polynomial ring. The computer system 102 implements strategic relinearization after homomorphic multiplications to control ciphertext size and noise growth throughout deep network computations, preventing excessive noise accumulation that would otherwise require frequent bootstrapping operations. The re-linearization process reduces the degree of the resulting ciphertexts from three elements back to two elements, maintaining computational efficiency while controlling noise growth during subsequent homomorphic operations.

At 410, the operations include performing homomorphic addition of re-linearized multiplication results to generate a respective similarity score. In an embodiment of the disclosure, the homomorphic addition combines each re-linearized multiplication result c_{relin,j} with the running total cₛᵤₘ initialized to encrypt zero, where the final similarity score is computed as cₛᵤₘ=Σⱼ₌₁^{d} c_{relin,j}. The homomorphic addition operation parses the current running total cₛᵤₘ=(c₀, c₁) and the re-linearized multiplication result c_{relin,j}=(c₀′, c₁′) as the two ciphertexts to be added, adds the components of the ciphertexts as cₛᵤₘ=(c₀+c₀′ mod q, c₁+c₁′ mod q), and returns the updated running total ciphertext cₛᵤₘ. The homomorphic addition operation iteratively combines all re-linearized multiplication results with the running total initialized to encrypt zero to compute the final dot product similarity score between the encrypted query embedding and the encrypted embedding associated with the candidate node. The similarity score remains encrypted throughout the computation process.

At 412, the operations include determining whether there are more candidate nodes to process. In an embodiment of the disclosure, the computer system 102 is configured to determine whether there are more candidate nodes remaining in the set of candidate nodes C that require similarity computation processing. If there are more candidate nodes to process, control passes to 414. Otherwise, if all candidate nodes have been processed, control passes to 416. The decision process enables systematic processing of all candidate nodes identified during the traversal of the hybrid search index structure 108.

At 414, the operations include incrementing the node index. In an embodiment of the disclosure, the computer system 102 is configured to increment the node index i to select the next candidate node nᵢ₊₁ from the set of candidate nodes for subsequent similarity computation processing. After incrementing the node index, control returns to 402 to select the next candidate node and continue the similarity computation operations from 404 to 410.

At 416, the operations include terminating the traversal. In an embodiment of the disclosure, the computer system 102 is configured to terminate the traversal process when all candidate nodes in the set of candidate nodes have been processed and their respective similarity scores have been computed through homomorphic operations. The traversal termination enables the computer system 102 to proceed with generating search results based on the computed similarity scores.

FIG. 5 is a diagram that illustrates a flowchart 500 for an encrypted search process using homomorphic similarity computations, in accordance with an embodiment of the disclosure. FIG. 5 is explained in conjunction with elements from FIG. 1, FIGS. 2A and 2B, FIG. 3, and FIG. 4. With reference to FIG. 5, there is shown the flowchart 500. The operations of the exemplary method may be executed by any computing system, for example, by the computer system 102 of FIG. 1. The operations of the flowchart 500 may start at 502 and implement an encrypted HNSW search algorithm for performing encrypted search using the hybrid search index structure 108.

At 502, the operations include initializing an empty priority queue PQ. In an embodiment of the disclosure, the computer system 102 is configured to initialize an empty priority queue PQ to manage candidate nodes during the hierarchical traversal of the hybrid search index structure 108. The initialization corresponds to the first step in the encrypted HNSW search algorithm where PQ is established as an empty priority queue for managing candidate nodes during the encrypted search operation.

At 504, the operations include inserting an entry point with encrypted similarity into the priority queue PQ. In an embodiment of the disclosure, the computer system 102 is configured to insert the entry point with the corresponding encrypted similarity score into the priority queue PQ through the operation PQ.insert(entryPoint, c_similarity). The entry point serves as the initial starting position for the hierarchical traversal process and is selected based on predetermined criteria or random selection from the highest level of the hierarchical structure. The encrypted similarity score c_similarity associated with the entry point is computed through the homomorphic similarity computations between the encrypted query embedding and the encrypted embedding associated with the entry point. The encrypted similarity score comprises ciphertexts corresponding to the similarity computation results, ensuring that the similarity values remain encrypted during the priority queue operations.

At 506, the operations include traversing the hybrid search index structure 108 from a top layer. In an embodiment of the disclosure, the computer system 102 is configured to traverse the hybrid search index structure 108 from the top layer of the hierarchical structure through a progressive traversal across hierarchical levels l from the top layer down to the bottom layer. The NSW graph 108a may be implemented as a HNSW graph, and the plurality of nodes of the HNSW graph is spread across hierarchical levels of the HNSW graph. The traversal of the hybrid search index structure 108 is a progressive traversal across the hierarchical levels of the HNSW graph to identify the set of candidate nodes. The traversal begins at the highest level with a small number of nodes and progressively moves through lower levels with increasing node density.

At 508, the operations include determining whether convergence has been reached in the current layer. In an embodiment of the disclosure, the computer system 102 is configured to determine whether convergence has been reached in the current layer of the hierarchical structure through the convergence condition evaluation. If convergence has not been reached, control passes to 510. Otherwise, if convergence has been reached, control passes to 516. The convergence determination may be based on criteria such as the stability of the similarity scores generated through the homomorphic similarity computations, the exhaustion of promising candidate nodes in the current layer, or the achievement of a predetermined search quality threshold. The convergence check ensures that the search process adequately explores each hierarchical level before proceeding to the next level or terminating the search operation.

At 510, the operations include popping the maximum node from the priority queue PQ. In an embodiment of the disclosure, the computer system 102 is configured to pop the maximum node from the priority queue PQ based on the similarity scores through the operation currentNode←PQ.popMax( ). The maximum node represents the candidate node with the highest similarity score to the encrypted query embedding among the nodes currently in the priority queue PQ. Each of the homomorphic similarity computations is performed during the traversal at a respective candidate node of the set of candidate nodes, and the traversal is based on a priority queue of the set of candidate nodes ordered by the similarity scores. The selection of the maximum node enables focused exploration of the most promising regions of the encrypted search space while maintaining the hierarchical structure of the traversal process.

At 512, the operations include performing homomorphic similarity computations with neighbors of the popped node. In an embodiment of the disclosure, the homomorphic operation module 110 is configured to perform the homomorphic similarity computations between the encrypted query embedding and encrypted embeddings associated with neighbors of the popped node through the operation c_similarity←HomDotProduct(c_query, n.embedding, evk). The homomorphic similarity computations comprise homomorphic dot product operations that include element-wise homomorphic multiplication between ciphertexts of the encrypted query embedding and ciphertexts of the encrypted embeddings associated with neighbor nodes, re-linearization of multiplication results based on evaluation keys evk to generate re-linearized multiplication results, and homomorphic addition of the re-linearized multiplication results to generate respective similarity scores. The neighbor nodes are identified through the plaintext connectivity information maintained in the NSW graph 108a.

At 514, the operations include inserting neighbors with encrypted similarity scores into the priority queue PQ. In an embodiment of the disclosure, the computer system 102 is configured to insert the neighbor nodes along with the computed encrypted similarity scores into the priority queue PQ through the operation PQ.insert(n, c_similarity). The insertion process maintains the ordering of the priority queue PQ based on the similarity scores generated through the homomorphic similarity computations, ensuring that nodes with higher similarity to the encrypted query embedding are prioritized for subsequent exploration. The encrypted similarity scores remain in the encrypted form as ciphertexts throughout the insertion process, preserving the privacy of the similarity computations while enabling effective navigation through the hybrid search index structure 108, After inserting the neighbors into the priority queue PQ, control returns to 508 to check for convergence in the current layer.

At 516, the operations include checking whether there are more layers to process. In an embodiment of the disclosure, the computer system 102 is configured to determine whether there are more hierarchical layers remaining in the HNSW graph structure that require processing, corresponding to the layer iteration for each layer from the top layer down to the bottom layer. If there are more layers to process, control passes to 518. Otherwise, if all layers have been processed, control passes to 520. The layer checking process ensures comprehensive exploration of the hierarchical structure of the hybrid search index structure 108, enabling the search algorithm to progressively refine the set of candidate nodes through multiple levels of the graph while maintaining the encrypted nature of the homomorphic similarity computations throughout the traversal process.

At 518, the operations include setting the current node as the entry point for the next layer. In an embodiment of the disclosure, the computer system 102 is configured to set the current node as the entry point for the next hierarchical layer of the HNSW graph through the operation entryPoint←currentNode. The current node represents the most promising candidate node identified during the traversal of the current layer and serves as the starting position for exploration of the next lower level in the hierarchical structure. After setting the entry point for the next layer, control returns to 506 to traverse the next hierarchical level, continuing the layer-by-layer exploration of the hybrid search index structure 108.

At 520, the operations include generating a search result based on the top-k nearest neighbors. In an embodiment of the disclosure, the computer system 102 is configured to generate the search result corresponding to the search request based on the top-k nearest neighbors identified through the hierarchical traversal process, returning the final top-k nearest neighbors from the priority queue PQ. The top-k nearest neighbors represent the encrypted embeddings with the highest similarity scores to the encrypted query embedding, as determined through the homomorphic similarity computations performed during the traversal of the hybrid search index structure 108. The search result generation process maintains the privacy of the underlying embedding data while providing meaningful results for subsequent processing operations in the retrieval-augmented generation workflow. The layer-by-layer hierarchical traversal approach progressively refines the search through hierarchical levels while maintaining the homomorphic similarity computations throughout the process, utilizing the priority queue mechanism ordered by similarity scores to efficiently identify the set of candidate nodes from the plurality of nodes of the hybrid search index structure 108.

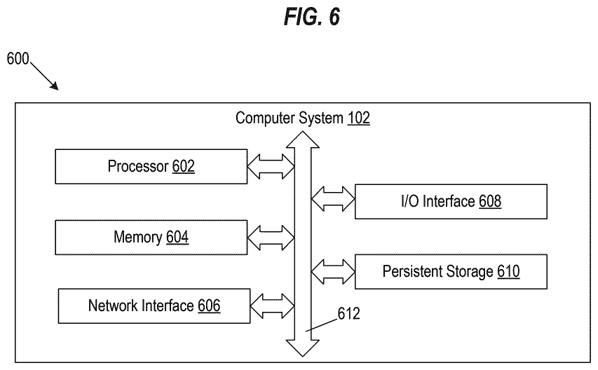

FIG. 6 is a block diagram 600 illustrating a computer system 102 for implementing privacy-preserving encrypted embedding search operations, in accordance with an embodiment of the disclosure. FIG. 6 is explained in conjunction with elements from FIG. 1, FIGS. 2A and 2B, FIG. 3, FIG. 4, and FIG. 5. With reference to FIG. 6, there is shown the block diagram 600 of the computer system 102 that includes a processor 602, a memory 604, a network interface 606, an input/output (I/O) interface 608, and a persistent storage 610, all interconnected through a bus 612. The computer system 102 may be configured to support the hybrid search index structure 108, the homomorphic operation module 110, the document store 112, the vector database 114, the embedding model 116, and the neural language model 118.

The processor 602 may include suitable logic, circuitry, and interfaces that may be configured to execute program instructions associated with encrypted embedding search operations to be executed by the computer system 102. The processor 602 may include any suitable special-purpose or general-purpose computer, computing entity, or processing device including various computer hardware or software modules and may be configured to execute instructions stored on any applicable computer-readable storage media. For example, the processor 602 may include a microprocessor, a microcontroller, a digital signal processor (DSP), an application-specific integrated circuit (ASIC), a Field-Programmable Gate Array (FPGA), or any other digital or analog circuitry configured to interpret and execute program instructions and process data. Although illustrated as a single processor in FIG. 6, the processor 602 may include any number of processors configured to, individually or collectively, perform or direct performance of any number of operations of the computer system 102, as described in the present disclosure. Some of the examples of the processor 602 may be a GPU, a CPU, a RISC processor, an ASIC processor, a CISC processor, a co-processor, and a combination thereof.

The processor 602 may be configured to execute encrypted embedding search operations including receiving an encrypted query embedding of a query embedding vector associated with a search request, traversing the hybrid search index structure 108 to identify a set of candidate nodes from a plurality of nodes, performing homomorphic similarity computations between the encrypted query embedding and encrypted embeddings associated with each candidate node of the set of candidate nodes, generating similarity scores based on the homomorphic similarity computations, and generating a search result corresponding to the search request based on the similarity scores. The processor 602 may implement multi-core processing capabilities that enable parallel execution of homomorphic operations through the homomorphic operation module 110 and traversal processes through the hybrid search index structure 108, supporting efficient resource utilization during encrypted embedding search operations. The processor 602 may support specialized instruction sets for homomorphic encryption operations including polynomial arithmetic, discrete Gaussian sampling, and ciphertext manipulation that enable efficient execution of fully homomorphic encryption schemes based on Ring Learning with Errors (RLWE) problems.

The processor 602 may be configured to execute homomorphic similarity computations comprising homomorphic dot product operations between the encrypted query embedding and encrypted embeddings associated with candidate nodes, where each homomorphic dot product operation comprises element-wise homomorphic multiplication between ciphertexts of the encrypted query embedding and ciphertexts of the encrypted embedding to generate multiplication results, re-linearization of each multiplication result based on evaluation keys to generate re-linearized multiplication results, and homomorphic addition of the re-linearized multiplication results to generate respective similarity scores. The processor 602 may implement specialized natural language processing capabilities that enable the neural language model 118 to generate sophisticated response data based on context documents retrieved through encrypted search operations, supporting retrieval-augmented generation applications where sensitive data remains encrypted throughout the search process.

In some embodiments, the processor 602 may be configured to interpret and execute program instructions and process data stored in the memory 604 and the persistent storage 610. In some embodiments, the processor 602 may fetch program instructions from the persistent storage 610 and load the program instructions in the memory 604. After the program instructions are loaded into the memory 604, the processor 602 may execute the program instructions. The processor 602 may be configured to execute the homomorphic operation module 110 to generate encrypted similarity computations comprising homomorphic dot products that include element-wise homomorphic multiplication, re-linearization based on evaluation keys, and homomorphic addition to generate similarity scores while maintaining complete privacy of underlying embedding data.

The memory 604 may include suitable logic, circuitry, and interfaces that may be configured to store program instructions executable by the processor 602. The memory 604 may be configured to store program instructions, data structures, and intermediate results for encrypted embedding search operations, including encrypted query embeddings, encrypted embeddings, similarity scores, and search results. The memory 604 may include computer-readable storage media for carrying or having computer-executable instructions or data structures stored thereon. Such computer-readable storage media may include any available media that may be accessed by a general-purpose or special-purpose computer, such as the processor 602. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices, or any other storage medium which may be used to carry or store particular program code in the form of computer-executable instructions or data structures and which may be accessed by a general-purpose or special-purpose computer,

The memory 604 may implement specialized data structures for efficient encrypted embedding representation that preserve homomorphic properties through polynomial-based encoding and specialized ciphertext operations, enabling cross-component optimization and bidirectional data flow through encrypted similarity computation functions. The memory 604 may maintain temporary storage for ciphertexts corresponding to elements of query embedding vectors and embedding vectors, supporting efficient homomorphic operations while preserving data confidentiality throughout the computation process. The memory 604 may store cryptographic parameters for homomorphic encryption schemes including public keys, secret keys, evaluation keys, and polynomial ring parameters, supporting efficient parameter access during encrypted embedding search operations and rapid inference during homomorphic similarity computations.

The network interface 606 may include suitable logic, circuitry, interfaces, and code that may be configured to establish communication between the computer system 102, the server 104, and the user device 106. The network interface 606 may enable communication with external systems through various protocols and connection types, supporting reception of encrypted query embeddings and transmission of search results through secure communication channels. The network interface 606 may be implemented by use of various known technologies to support wired or wireless communication of the computer system 102. The network interface 606 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and a local buffer.

The network interface 606 may communicate via wireless communication with networks, such as the Internet, an Intranet, and a wireless network, such as a cellular telephone network, a wireless local area network (LAN) and a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi), voice over Internet Protocol (VoIP), light fidelity (Li-Fi), or Wi-MAX. The network interface 606 may facilitate real-time encrypted embedding search operations and reception of search requests for privacy-preserving information retrieval. The network interface 606 may implement secure communication protocols that protect sensitive encrypted embedding data during transmission while enabling comprehensive encrypted search capabilities across different deployment environments.

The I/O interface 608 may include suitable logic, circuitry, interfaces, and code that may be configured to receive inputs and provide outputs for encrypted embedding search operations. The I/O interface 608 may include various input and output devices, which may be configured to communicate with the processor 602 and other components, such as the network interface 606. Examples of the input devices may include, but are not limited to, a touch screen, a keyboard, a mouse, a joystick, and a microphone. Examples of the output devices may include, but are not limited to, a display and a speaker. The I/O interface 608 may provide connectivity to the user device 106 and support interaction with the user interface 120 for configuration of encrypted embedding search parameters and presentation of search results.

The I/O interface 608 may enable the user 122 to specify the input query 124 including natural language queries, image data, audio signals, or multimodal content and receive the response data 126 including contextually relevant responses generated through privacy-preserving retrieval-augmented generation processes. The I/O interface 608 may support dashboard and visualization capabilities for encrypted search result presentation, administrative interfaces for cryptographic key management, and real-time monitoring capabilities for continuous encrypted embedding search operations in production environments.

The persistent storage 610 may include suitable logic, circuitry, and interfaces that may be configured to store program instructions executable by the processor 602, operating systems, and application-specific information, such as logs and encrypted embedding databases. The persistent storage 610 may include computer-readable storage media for carrying or having computer-executable instructions or data structures stored thereon. Such computer-readable storage media may include any available media that may be accessed by a general-purpose or special-purpose computer, such as the processor 602. By way of example, and not limitation, such computer-readable storage media may include tangible or non-transitory computer-readable storage media including Compact Disc Read-Only Memory (CD-ROM) or other optical disk storage, magnetic disk storage or other magnetic storage devices, flash memory devices, or any other storage medium which may be used to carry or store particular program code in the form of computer-executable instructions or data structures and which may be accessed by a general-purpose or special-purpose computer.

The persistent storage 610 may provide long-term storage for encrypted embeddings, cryptographic keys, hybrid search index structures, and context documents used for retrieval-augmented generation applications. The persistent storage 610 may maintain comprehensive records of encrypted embedding search operations across different vector databases and homomorphic encryption schemes. The persistent storage 610 may store specialized cryptographic parameters including public keys generated by sampling discrete Gaussian distributions over polynomial rings, secret keys for homomorphic decryption schemes, evaluation keys for re-linearization operations, and derived keys for multi-tenant access control, supporting comprehensive encrypted embedding search capabilities across multiple search sessions. The persistent storage 610 may implement automated backup and recovery mechanisms that ensure continuity of encrypted embedding search operations and preservation of cryptographic data for security and audit purposes.

The bus 612 may provide communication pathways between all components of the computer system 102. The bus 612 may support parallel processing architectures that enable simultaneous execution of homomorphic similarity computations, hybrid search index traversal processes, encrypted embedding retrieval operations, and neural language model inference procedures. The bus 612 may implement specialized communication protocols optimized for homomorphic encryption workloads, including efficient transfer of ciphertexts, cryptographic parameters, and encrypted similarity computation results between the processor 602, the memory 604, and other system components. The bus 612 may enable real-time coordination between components of the homomorphic operation module 110.

Modifications, additions, or omissions may be made to the computer system 102 without departing from the scope of the present disclosure. For example, in some embodiments, the computer system 102 may include any number of other components that may not be explicitly illustrated or described.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
in a computer system that comprises a processor:
receiving an encrypted query embedding of a query embedding vector associated with a search request;
traversing a hybrid search index structure to identify a set of candidate nodes from a plurality of nodes of the hybrid search index structure, wherein
each node of the plurality of nodes is associated with a respective encrypted embedding of a plurality of encrypted embeddings, and
the respective encrypted embedding comprises ciphertexts corresponding to elements of an embedding vector of a plurality of embedding vectors;
performing homomorphic similarity computations between the encrypted query embedding and the respective encrypted embedding associated with each candidate node of the set of candidate nodes;
generating similarity scores based on the homomorphic similarity computations; and
generating a search result corresponding to the search request based on the similarity scores.

2. The computer-implemented method according to claim 1, wherein the encrypted query embedding comprises ciphertexts corresponding to elements of the query embedding vector.

3. The computer-implemented method according to claim 1, further comprising:
retrieving an initial plurality of embedding vectors from a vector database;
preprocessing the initial plurality of embedding vectors through a normalization and transformation pipeline to obtain the plurality of embedding vectors;
encrypting each embedding vector of the plurality of embedding vectors based on a homomorphic encryption scheme to generate the plurality of encrypted embeddings,
wherein the plurality of encrypted embeddings comprises the respective encrypted embedding of each embedding vector of the plurality of embedding vectors; and
constructing the hybrid search index structure comprising a Navigable Small-World Graph (NSW) graph,
wherein the NSW graph comprises the plurality of nodes and edges between the plurality of nodes, and
connectivity information for the edges is in plaintext.

4. The computer-implemented method according to claim 3, wherein the NSW graph is a hierarchical navigable small world (HNSW) graph,
the plurality of nodes of the HNSW graph is spread across hierarchical levels of the HNSW graph, and
the traversal of the hybrid search index structure is a progressive traversal across the hierarchical levels of the HNSW graph to identify the set of candidate nodes.

5. The computer-implemented method according to claim 3, wherein the preprocessing comprises:
normalizing each embedding vector of the initial plurality of embedding vectors to a unit length to obtain a plurality of normalized embedding vectors;
applying a scaling transformation based on specific scaling factors to each normalized embedding vector of the plurality of normalized embedding vectors to obtain a plurality of scaled embedding vectors; and
adding a randomization factor from a multivariate normal distribution to each scaled embedding vector of the plurality of scaled embedding vectors to obtain the plurality of embedding vectors.

6. The computer-implemented method according to claim 3, wherein the homomorphic encryption scheme comprises a fully homomorphic encryption (FHE) scheme based on a Ring Learning with Errors (RLWE) problem.

7. The computer-implemented method according to claim 3, further comprising selecting the homomorphic encryption scheme based on a data type of the elements in the embedding vector,
wherein the homomorphic encryption scheme comprises at least one of Cheon-Kim-Kim-Song (CKKS) scheme, Brakerski/Fan-Vercauteren (BFV) scheme, Brakerski-Gentry-Vaikuntanathan (BGV) scheme, Fully Homomorphic Encryption over Torus (TFHE) scheme, or Ring Learning with Errors (RLWE) scheme.

8. The computer-implemented method according to claim 3, further comprising:
sampling discrete Gaussian distributions over a polynomial ring to generate a public key and a secret key; and
encrypting the plurality of embedding vectors based on the public key to generate the plurality of encrypted embeddings.

9. The computer-implemented method according to claim 1, further comprising:
identifying, from the plurality of encrypted embeddings, a set of encrypted embeddings similar to the encrypted query embedding based on the similarity scores;
applying a homomorphic decryption scheme to the identified set of encrypted embeddings to generate a set of decrypted embedding vectors;
querying a vector database to retrieve a set of context documents associated with the set of decrypted embedding vectors; and
generating the search result further based on the set of context documents.

10. The computer-implemented method according to claim 9, further comprising:
ranking the set of context documents based on the similarity scores;
selecting at least one context document from the ranked set of context documents;
feeding a neural language model with a prompt to generate response data, wherein the prompt comprises the at least one context document and content of the search request; and
generating the search result based on the response data.

11. The computer-implemented method according to claim 9, wherein the applying of the homomorphic decryption scheme comprises applying a secret key or a derived secret key to the identified set of encrypted embeddings to generate the set of decrypted embedding vectors, and
the secret key is based on a sampling of discrete Gaussian distributions over a polynomial ring.

12. The computer-implemented method according to claim 1, wherein the performing of the homomorphic similarity computations comprises:
performing homomorphic dot product operations between the encrypted query embedding and the respective encrypted embedding associated with each respective candidate node of the set of candidate nodes.

13. The computer-implemented method according to claim 12, wherein each of the homomorphic dot product operations comprises:
an element-wise homomorphic multiplication between ciphertexts of the encrypted query embedding and the ciphertexts of the respective encrypted embedding to generate multiplication results,
a re-linearization of each of the multiplication results based on evaluation keys to generate re-linearized multiplication results, and
a homomorphic addition of the re-linearized multiplication results to generate a respective similarity score of the similarity scores, and
wherein the evaluation keys are based on a sampling of discrete Gaussian distributions over a polynomial ring.

14. The computer-implemented method according to claim 1, wherein each of the homomorphic similarity computations is performed during the traversal at a respective candidate node of the set of candidate nodes, and
the traversal is based on a priority queue of the set of candidate nodes ordered by the similarity scores.

15. The computer-implemented method according to claim 1, wherein the identification of the set of candidate nodes is performed without a decryption of the ciphertexts of the respective encrypted embedding and ciphertexts of the encrypted query embedding.

16. A computer system, comprising:
a processor configured to:
receive an encrypted query embedding of a query embedding vector associated with a search request;
traverse a hybrid search index structure to identify a set of candidate nodes from a plurality of nodes of the hybrid search index structure, wherein
each node of the plurality of nodes is associated with a respective encrypted embedding of a plurality of encrypted embeddings, and
the respective encrypted embedding comprises ciphertexts corresponding to elements of an embedding vector of a plurality of embedding vectors;
perform homomorphic similarity computations between the encrypted query embedding and the respective encrypted embedding associated with each candidate node of the set of candidate nodes;
generate similarity scores based on the homomorphic similarity computations; and
generate a search result corresponding to the search request based on the similarity scores.

17. The computer system according to claim 16, wherein the processor is further configured to:
retrieve an initial plurality of embedding vectors from a vector database;
preprocess the initial plurality of embedding vectors through a normalization and transformation pipeline to obtain the plurality of embedding vectors;
encrypt each embedding vector of the plurality of embedding vectors based on a homomorphic encryption scheme to generate the plurality of encrypted embeddings,
wherein the plurality of encrypted embeddings comprises the respective encrypted embedding of each embedding vector of the plurality of embedding vectors; and
construct the hybrid search index structure comprising a Navigable Small-World Graph (NSW) graph,
wherein the NSW graph comprises the plurality of nodes and edges between the plurality of nodes, and
connectivity information for the edges is in plaintext.

18. The computer system according to claim 16, wherein the processor is further configured to:
identify, from the plurality of encrypted embeddings, a set of encrypted embeddings similar to the encrypted query embedding based on the similarity scores;
apply a homomorphic decryption scheme to the identified set of encrypted embeddings to generate a set of decrypted embedding vectors;
query a vector database to retrieve a set of context documents associated with the set of decrypted embedding vectors; and
generate the search result further based on the set of context documents.

19. The computer system according to claim 16, wherein the identification of the set of candidate nodes is performed without a decryption of the ciphertexts of the respective encrypted embedding and ciphertexts of the encrypted query embedding.

20. A computer-program product, comprising:
one or more computer-readable storage media; and
program instructions stored on the one or more computer-readable storage media to perform operations comprising:
receiving an encrypted query embedding of a query embedding vector associated with a search request;
traversing a hybrid search index structure to identify a set of candidate nodes from a plurality of nodes of the hybrid search index structure, wherein
each node of the plurality of nodes is associated with a respective encrypted embedding of a plurality of encrypted embeddings, and
the respective encrypted embedding comprises ciphertexts corresponding to elements of an embedding vector of a plurality of embedding vectors;
performing homomorphic similarity computations between the encrypted query embedding and the respective encrypted embedding associated with each candidate node of the set of candidate nodes;
generating similarity scores based on the homomorphic similarity computations; and
generating a search result corresponding to the search request based on the similarity scores.
